(19) United States
(12) Patent Application Publication
(10) Pub. No.: US 2026/0291882 A1
(43) Pub. Date: Sep. 24, 2026

(54) SYSTEM

(71) Applicant: SoftBank Group Corp., Tokyo (JP)

(72) Inventor: Kazumasa FUKUDA, Tokyo (JP)

(73) Assignee: SoftBank Group Corp., Tokyo (JP)

(21) Appl. No.: 19/565,601

(22) Filed: Mar. 13, 2026

(30) Foreign Application Priority Data
Mar. 19, 2025 (JP) 2025-045150

(51) Int. Cl. H04L 51/02; G06F 40/20; G06N 20/00

(52) U.S. Cl. CPC H04L 51/02; G06F 40/20; G06N 20/00

(57) ABSTRACT

A system includes a processor that is configured to record a conversation history from a user and store the conversation history in a database, analyze and learn a tone and thought pattern of the user by using a natural language processing technique based on the recorded conversation history, and predict a reply of the user on the basis of the learned tone and thought pattern by using a generative AI model and generate a prompt for instructing message generation.

### CROSS-REFERENCE TO RELATED APPLICATION

This application is based on and claims priority under 35 USC 119 from Japanese Patent Application No. 2025-045150 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional text generation systems and communication support tools typically generate messages based only on generic language models that are not sufficiently tailored to an individual user. As a result, the generated messages often fail to reflect the user's characteristic tone, thought patterns, and emotional context, which can lead to communications that feel unnatural to the user and may not match the user's intended style or nuance. Furthermore, conventional systems generally do not dynamically adapt their outputs based on the user's emotional state, and therefore may produce messages that are inappropriate in view of the user's current feelings or situation.

In view of the foregoing, an object of the present invention is to provide a system capable of recording and storing a user's conversation history, analyzing and learning the user's tone and thought patterns from the recorded conversation history using natural language processing techniques, and predicting the user's reply using a generative AI model based on the learned tone and thought patterns. Another object of the present invention is to provide a system capable of generating prompts for instructing message generation, generating messages based on the prompts, and presenting such messages to the user in a manner that is suited to the user's individual communication style. A further object of the present invention is to provide a system capable of analyzing the user's emotional state and adjusting the generated messages based on the result of the analysis, thereby improving the naturalness, appropriateness, and personalization of the generated messages.

### SUMMARY

In order to achieve the above objects, a system according to one aspect of the present invention comprises a processor, wherein the processor is configured to record a conversation history from a user and store the conversation history in a database. The processor is further configured to analyze and learn a tone and thought pattern of the user by using a natural language processing technique based on the recorded conversation history. The processor is also configured to predict a reply of the user on the basis of the learned tone and thought pattern by using a generative AI model and generate a prompt for instructing message generation.

In addition, in one embodiment, the processor is configured to generate a message based on the generated prompt and present the message to the user. By doing so, the system can present to the user a candidate message that reflects the user's own learned tone and thought patterns, thereby enabling efficient and consistent communication support.

Furthermore, in another embodiment, the processor is configured to analyze an emotional state of the user and adjust the generated message based on a result of the analysis. For example, the processor may modify the level of politeness, directness, or emotional intensity of the generated message in accordance with the analyzed emotional state of the user. Through these configurations, the system can generate and present messages that not only match the user's characteristic style but are also adapted to the user's current emotional context, thereby solving the problems of insufficient personalization and contextual appropriateness found in conventional systems.

The term “system” refers to an apparatus including at least one processor and, where applicable, associated memory, storage, communication interfaces, and other hardware or software components that cooperate to perform the processing described in the claims.

The term “processor” refers to one or more hardware processing units, such as a central processing unit (CPU), a microprocessor, a digital signal processor (DSP), or a specialized AI accelerator, which execute instructions to perform the functions described in the claims, and may include or cooperate with memory storing such instructions.

The term “conversation history” refers to a collection of one or more textual or text-equivalent records of exchanges involving the user, including messages transmitted by the user and, optionally, messages received by the user, along with associated metadata such as timestamps, sender identifiers, and context information.

The term “user” refers to a human operator who interacts with the system, provides conversation inputs, reviews generated messages, and optionally edits or approves messages suggested by the system.

The term “database” refers to any structured data storage system, including relational databases, NoSQL databases, file-based storage, or other persistent storage mechanisms, in which the conversation history and related information are recorded and managed.

The term “natural language processing technique” refers to any computational method or algorithm for analyzing, interpreting, or processing human language in textual or text-equivalent form, including but not limited to tokenization, parsing, semantic analysis, sentiment analysis, feature extraction, and machine learning-based language modeling.

The term “tone” refers to stylistic and expressive characteristics of the user's language usage, such as formality level, politeness, emotional nuance, typical phrasing, and overall manner of expression as inferred from the conversation history.

The term “thought pattern” refers to recurring tendencies in the user's way of expressing ideas, reasoning, or structuring information, including habitual sentence structures, preferred argumentation styles, and typical ways of responding to particular types of content or situations.

The term “learn” refers to a process by which the processor, using one or more algorithms or models, derives, updates, or refines internal parameters or representations (such as feature vectors or model weights) that characterize the user's tone and thought patterns based on the recorded conversation history.

The term “generative AI model” refers to a machine learning model configured to generate natural language text, such as a neural network-based language model, including but not limited to transformer-based models, that produces text outputs in response to input data or prompts.

The term “predict a reply” refers to generating, by use of the generative AI model, text that represents a candidate response that the user would be likely to produce, based on the learned tone and thought patterns and optionally on the current conversational context.

The term “prompt” refers to an input text or structured instruction data prepared by the processor and provided to the generative AI model in order to cause the generative AI model to generate a message, the prompt including information such as context, constraints, or style indications.

The term “message” refers to a unit of text generated or suggested by the system for use in communication, such as a reply in a conversation, an email body, or another textual communication element intended to be presented to or transmitted by the user.

The term “present the message to the user” refers to causing the message to be output in a form perceivable by the user, for example by displaying the message on a screen, rendering it in a graphical user interface, or otherwise making it available for review or editing.

The term “emotional state” refers to an inferred condition representing one or more aspects of the user's emotions, such as happiness, sadness, anger, stress, or calmness, as estimated from the user's conversation history or current input using natural language processing or related analysis techniques.

The term “adjust the generated message” refers to modifying at least a part of the generated message, including but not limited to changing word choice, sentence length, tone, politeness level, or emotional intensity, based on the analyzed emotional state of the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

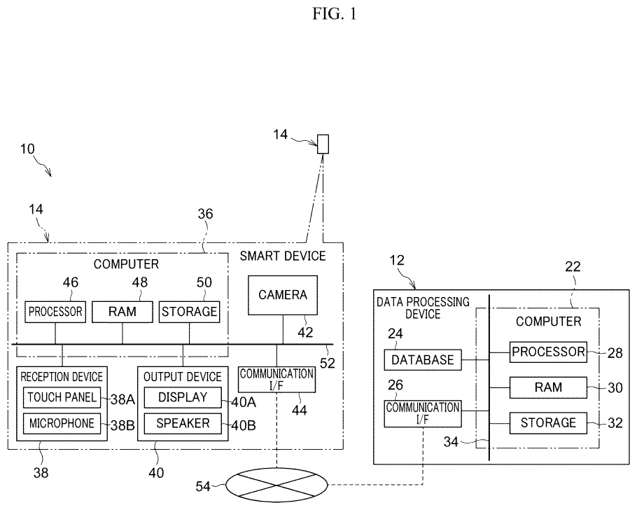

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

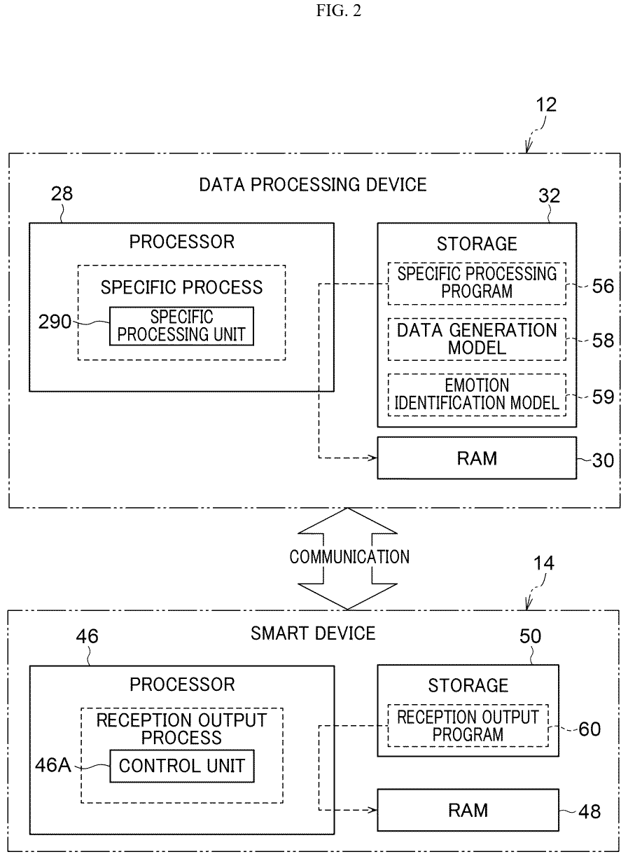

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented conversation assistance systems typically generate reply suggestions using generic language models that are trained on large, heterogeneous datasets. Such systems often disregard fine-grained individual user characteristics, including user-specific response tendencies, expression styles, and long-term behavioral patterns. As a result, the generated replies tend to be stylistically inconsistent with the user's own manner of communication, thereby requiring extensive manual correction by the user and reducing overall communication efficiency.

Moreover, in many existing systems, conversation history is either not persistently structured, or is used only as a short contextual window for a single generation step. These systems generally do not construct and maintain a user-specific learning model that incrementally adapts to the user based on accumulated dialogue history and actual usage behavior.

Consequently, the underlying computer processes do not fully exploit available historical data, and the adaptation of the system to the user remains superficial and limited in precision. Further, known systems typically invoke generative models with relatively static or simplistic prompt sentences that are not systematically tailored to the user's learned reply patterns, emotional state, or interaction context. This results in suboptimal utilization of the generative model's capacity, as the model is not guided by a rich, dynamically structured prompt reflecting both user-specific features and current dialogue conditions. From a computer technology perspective, this leads to inefficient use of computational resources, repeated generation of low-relevance candidates, and increased network and processing overhead due to retries and user corrections.

In addition, feedback information indicating whether a user adopted, edited, or discarded a suggested reply is rarely integrated as structured usage history into the training or retraining pipeline of user-specific models. Without such feedback-aware updating, the system's learning loop remains incomplete, and the computer cannot systematically improve its future behavior based on observable user actions. This limits the potential for continuous optimization of model parameters and prompt construction logic at the system level.

Therefore, there is a need for an improved computer-implemented system that: (i) structures and preprocesses conversation history in a manner suitable for constructing user-specific sequential learning models; (ii) dynamically generates prompt sentences for a generative AI model based on learned reply patterns, user expression styles, and emotional state; and (iii) integrates usage feedback into a retraining process. Such a system should improve the technical operation of the underlying computer components, including storage, processing, and model inference, to generate more relevant and consistent reply candidates while reducing user editing burden and resource consumption.

The specific processing by the specific processing unit 290 of the data processing device 12 in Example 1 is realized by the following means.

The present invention provides a server comprising a processor configured to acquire dialogue content with a user as dialogue history and store the dialogue history in an information management device in association with identification information and time information; to perform preprocessing on the dialogue history stored in the information management device by using a natural language processing technique, the preprocessing including word segmentation, removal of unnecessary information, and emotion estimation, and to generate feature information indicating a response tendency and an expression style of the user based on a result of the preprocessing; to construct, based on the feature information and the dialogue history, a sequential learning model by using a machine-learning algorithm, and to cause the sequential learning model to learn a reply pattern of the user; to construct, based on the reply pattern of the user estimated by the sequential learning model and a current dialogue situation, a prompt sentence including an instruction sentence to be input to a generative information processing model, and to add condition information indicating the expression style, response length, and politeness level of the user to the prompt sentence; to input the prompt sentence to the generative information processing model and cause the generative information processing model to generate a reply candidate sentence that is expected to be transmitted by the user; and to record the generated reply candidate sentence as candidate information in association with usage history information in the information management device and to update the usage history information for use in retraining of the sequential learning model. This enables the server to technically improve the operation of the conversation assistance process by structuring and preprocessing dialogue data for efficient model training, by dynamically tailoring prompt sentences for the generative AI model using user-specific learned patterns and emotional state, and by closing the feedback loop through usage-history-based retraining, thereby enhancing the accuracy, relevance, and computational efficiency of reply candidate generation on the underlying computing infrastructure.

The term “dialogue history” refers to electronic data representing one or more sequences of dialogue content exchanged between a user and another party, including at least message text and being stored together with associated identification information and time information.

The term “identification information” refers to electronic information used by a computing system to uniquely or quasi-uniquely identify an entity involved in a dialogue, such as a user, a device, an account, or a session.

The term “time information” refers to electronic information indicating a temporal attribute of dialogue content, such as a timestamp, time interval, or chronological order indicator.

The term “information management device” refers to one or more hardware and software components configured to store, manage, and retrieve data, including but not limited to a storage device, a database system, or a data management server.

The term “natural language processing technique” refers to a computerized method or algorithm that analyzes or transforms text or speech expressed in a natural language, including operations such as tokenization, morphological analysis, syntactic analysis, semantic analysis, and sentiment analysis.

The term “word segmentation” refers to a natural language processing operation in which a computing system divides a text string into units such as words, tokens, or subword elements according to predefined linguistic rules or learned models.

The term “removal of unnecessary information” refers to a preprocessing operation in which a computing system deletes or filters out elements of dialogue data that are deemed irrelevant or redundant for subsequent analysis, such as stopwords, symbols, markup, or noise.

The term “emotion estimation” refers to a computational process in which a system analyzes dialogue content and outputs one or more indicators representing an inferred emotional state, such as polarity, arousal level, or categorical emotion labels.

The term “feature information” refers to structured data derived from raw dialogue history through preprocessing and analysis, the structured data representing characteristics of the dialogue or the user, such as response tendencies, expression styles, sentiment scores, or statistical attributes.

The term “response tendency” refers to a pattern or propensity in a user's replies, represented as data, including aspects such as typical length, level of detail, frequency of certain expressions, or common response structures.

The term “expression style” refers to stylistic characteristics of a user's communication, represented as data, including factors such as formality level, politeness level, tone, vocabulary preference, and typical sentence structure.

The term “sequential learning model” refers to a machine-learning model that processes input data as an ordered sequence, such as a recurrent neural network, a sequence-to-sequence model, or a transformer-based model, and learns temporal or positional dependencies within the sequence.

The term “machine-learning algorithm” refers to a computational procedure that adjusts parameters of a model based on training data in order to perform prediction, classification, generation, or other inferential tasks without being explicitly programmed for each possible input.

The term “reply pattern” refers to a learned representation of how a user typically replies in dialogues, including structural, lexical, and contextual properties of the user's replies, as derived and encoded by a learning model.

The term “current dialogue situation” refers to information representing a present state of a dialogue at the time of generating a reply, including at least one of recent messages, participants' roles, ongoing topic, and temporal context.

The term “prompt sentence” refers to a text sequence generated by a computing system and provided as input to a generative information processing model, the text sequence including instructions, context, and conditions that guide the generation of an output sentence.

The term “instruction sentence” refers to a portion of a prompt sentence that explicitly describes a task or behavior required of a generative information processing model, such as predicting a reply or generating text in a specified style.

The term “generative information processing model” refers to a computational model that receives input data, such as a prompt sentence, and outputs newly generated information, such as a reply sentence, based on learned probability distributions or generation rules.

The term “condition information” refers to data included in or associated with a prompt sentence that specifies constraints or target attributes for generated output, such as expression style, response length, politeness level, or language.

The term “response length” refers to a quantitative or qualitative specification of the size of a reply, including but not limited to the number of tokens, words, characters, or sentences.

The term “politeness level” refers to a qualitative or quantitative indicator specifying a desired degree of politeness or formality in a reply, as interpreted by a computing system when generating or adjusting text.

The term “reply candidate sentence” refers to a sentence or sequence of sentences generated by a generative information processing model as a proposed reply that a user may transmit in a dialogue.

The term “candidate information” refers to data representing at least one reply candidate sentence together with associated metadata, such as generation parameters, timestamps, or links to dialogue context.

The term “usage history information” refers to data representing how a user interacted with one or more reply candidate sentences, including information indicating adoption, modification, or rejection of the candidate sentences.

The term “retraining” refers to a process in which a sequential learning model is further trained or fine-tuned using additional data, such as updated dialogue history and usage history information, in order to update model parameters and improve performance.

The term “terminal device” refers to an electronic device operated by or accessible to a user, including but not limited to a smartphone, tablet, personal computer, or wearable device, that can display information and transmit data over a network.

The term “display device” refers to a hardware component of a terminal device or server system that is configured to visually present text, images, or graphical user interfaces to a user.

The term “modifiable presentation sentence” refers to a displayed textual representation of a reply candidate sentence that a user can modify through an input interface before sending or discarding.

The term “operation information” refers to electronic data indicating user actions with respect to a displayed reply candidate sentence, including at least one of a selection operation, an editing operation, and a discarding operation.

The term “emotional state index” refers to one or more numerical or categorical values calculated from dialogue content or preprocessing results that represent an inferred emotional condition of a user at a given time.

The term “expression content” refers to semantic and lexical aspects of a text output, including word choice, phrasing, and informational elements presented in a reply or prompt.

The term “writing style” refers to structural and stylistic attributes of a text, including sentence length, formality, tone, use of specific linguistic constructions, and overall textual manner.

In one embodiment, a server, a terminal, and a network cooperate to implement a conversation assistance system that generates reply candidate sentences tailored to an individual user's expression style and response tendency. The server executes a program stored in a non-transitory computer-readable medium. The program causes a processor of the server to control a storage device, a database system, a machine-learning subsystem, and a generative AI subsystem as described below.

The server includes at least one central processing unit (CPU), an optional graphics processing unit (GPU), a main memory, a persistent storage device such as a solid-state drive, and a network interface. The server executes an operating system such as a general-purpose server operating system. The storage device of the server implements an information management device using a relational database management system such as a general-purpose relational database. The database stores dialogue history, feature information, usage history information, and model parameters in structured tables.

The terminal includes a CPU, a main memory, a display device such as a liquid crystal display or organic light-emitting diode display, an input interface such as a touch screen and keyboard, and a network interface such as a wireless communication interface. The terminal executes an operating system such as a mobile or desktop operating system and a client application that communicates with the server via a network protocol such as Hypertext Transfer Protocol Secure.

In one configuration, the server provides an application programming interface that receives dialogue content from the terminal. The server stores dialogue content as dialogue history in the database. Each entry in the dialogue history includes a user identifier, a session identifier, a role field indicating whether the speaker is the user or another participant, a message text field containing the text of the message, and a timestamp field indicating time information. The server uses an object-relational mapping framework to map these fields to database records. By structuring the dialogue history in normalized tables, the server can efficiently query recent dialogue segments for downstream processing, thereby reducing input/output operations compared with ad hoc log files.

The server applies natural language processing techniques to text segments in the dialogue history. The server loads a language processing library such as an English language model of a natural language toolkit or a modern natural language library implemented in a high-level language runtime. The server performs word segmentation (tokenization) on each message by converting a character string into a sequence of tokens. The server then removes tokens that are considered unnecessary information, such as common function words and non-informative symbols, using a predefined stopword list and regular expression filters. The server optionally performs lemmatization to convert inflected forms to base forms. These preprocessing operations convert unstructured message text into normalized token sequences, which directly reduce vocabulary size and improve the stability of subsequent machine-learning training, thereby improving computational efficiency.

The server estimates an emotional state index for at least some user messages. The server uses a sentiment analysis model such as a recurrent neural network classifier or a transformer-based classifier implemented in a deep learning framework such as a general-purpose tensor-based framework. The server inputs the tokenized message into an embedding layer to obtain dense vector representations for tokens, applies one or more recurrent or attention-based layers, and outputs a sentiment polarity score and possibly categorical emotion labels. The server stores the resulting emotion estimation as an emotional state index in a dedicated feature table. This emotional state index is then linked to the corresponding dialogue history entry via a foreign key. By storing these derived features, the system avoids recomputing sentiment during every generation request, reducing processing time.

Based on the preprocessed token sequences and emotion indices, the server computes feature information that represents response tendencies and expression styles of the user. The server calculates statistics such as average length of replies in tokens, distribution of politeness markers, frequency of specific n-grams, and transition patterns between user emotion indices and reply types. The server encodes these statistics into numerical feature vectors. For example, the server may compute a vector where each dimension corresponds to a metric such as mean sentence length, proportion of interrogative sentences, ratio of positive to negative sentiment, and average formality score estimated by a style classifier. The server stores these feature vectors in the database and also uses them as input to a sequential learning model.

In one embodiment, the server constructs a sequential learning model using a deep learning framework. The sequential learning model is implemented as a neural network with an embedding layer, one or more recurrent layers such as long short-term memory layers, and a fully connected output layer. The input to the model is a sequence of tokens representing one or more past dialogue turns, optionally augmented with auxiliary features such as emotion indices and dialogue role indicators. The server trains the model using supervised learning. The target output is the sequence of tokens in the user's actual reply. The server defines an objective function such as a cross-entropy loss over token distributions. The server computes gradients of the loss with respect to network parameters by backpropagation through time and updates the parameters using an optimization algorithm such as an adaptive gradient descent method.

The server uses one or more GPUs to accelerate matrix multiplications and other tensor operations during training and inference. By using a sequential learning model that encodes long-range dependencies in the dialogue history, the server can capture user-specific reply patterns that depend not only on the immediately preceding message but on deeper context, thereby improving prediction accuracy compared with simple rule-based or n-gram models. The model structure, including the dimensionality of embeddings, the number of recurrent layers, and the size of hidden states, is selected to balance prediction performance and computational resource usage.

The server uses output representations of the sequential learning model to estimate a reply pattern of the user. For example, the server can extract a latent vector from the final hidden state of the recurrent network, which encodes the user's distinctive style and behavioral patterns. The server can further compute scalar values representing an inferred preferred response length, an inferred politeness level, or a probability distribution over stylistic categories. These outputs are used as condition information when constructing a prompt sentence.

In one embodiment, the server constructs a prompt sentence to be input to a generative AI model. The generative AI model is implemented as a large-scale transformer network either deployed on the server or accessed via an external inference service. The server constructs the prompt sentence as a concatenation of several components: system instructions, user style description, recent dialogue history, and a task specification. For example, the server may construct a prompt sentence such as:

“System: You are a generative AI model that writes replies in the user's style.

User style: The user prefers short, polite, factual messages.

Conversation:

Friend: ‘How is the weather recently?’

Task: Generate the reply that the user would most likely send.”

In another example, the server may construct a prompt sentence as follows: “System: Write a reply in the user's typical style.

User's characteristics: friendly, concise, slightly informal.

Current message: ‘How is the weather recently?’

Constraint: Answer in one or two sentences, mention today's weather and temperature.

Output: Only the reply text, no explanations.”

The server inserts condition information such as the user's preferred expression style, response length, and politeness level into the prompt sentence, using values computed from the sequential learning model and emotion estimation. The server may also include an indication of the user's current emotional state, for example, “The user is currently slightly negative; use a supportive but not overly cheerful tone.” By encoding these conditions explicitly in the prompt sentence, the server constrains the generative AI model to a narrower search space in token generation, which reduces the number of tokens that must be processed and improves the relevance of generated replies.

The server inputs the constructed prompt sentence into the generative AI model. The generative AI model processes the prompt by embedding tokens, applying multiple self-attention layers, and decoding an output sequence token-by-token according to a probabilistic language model. The server sets generation parameters such as maximum token count, sampling temperature, and nucleus sampling threshold to control diversity and length.

Because the prompt includes user-specific style information and current dialogue conditions, the generative AI model can converge more quickly to a suitable reply without multiple generation attempts, thereby reducing computational time on the server and decreasing network traffic between the server and a remote inference service.

The server obtains the generated token sequence as a reply candidate sentence, decodes it into text, and optionally performs post-processing such as trimming whitespace, removing unwanted speaker labels, and enforcing maximum length. The server performs safety filtering using a classification model trained to detect offensive or prohibited content. If the reply candidate sentence fails safety checks, the server discards it or regenerates another candidate with adjusted constraints.

The server records the generated reply candidate sentence as candidate information in the database, associating it with the corresponding dialogue history entry, the user identifier, and the prompt parameters used. When the terminal presents the reply candidate sentence to the user, the server later receives operation information from the terminal indicating whether the user adopted the candidate as-is, edited the candidate, or discarded it. The server stores this operation information as usage history information. In later training cycles, the server uses the usage history information as additional labels for the sequential learning model. For instance, the server can weight training examples where the user accepted the candidate more heavily, or can apply logistic regression on top of latent vectors to predict acceptance probabilities. This feedback mechanism allows the server to adjust model parameters and feature extraction routines so that future reply predictions align more closely with user preferences.

The terminal presents the reply candidate sentence to the user using a graphical user interface. The terminal receives the reply candidate sentence and related metadata via a network connection. The terminal renders the sentence in an input area or in a suggestion region distinct from manually typed messages. The user can tap a control to adopt the sentence directly, or tap another control to open the sentence in an editable field. If the user edits the sentence, the terminal records the original candidate and the edited text and transmits both to the server. By capturing the difference between generated content and the user's final message, the system can quantify the degree of fit of the candidate and refine future prompts.

In addition to the primary embodiment described above, various alternative configurations may be used. In one variation, the sequential learning model is implemented as a transformer encoder rather than a recurrent network. In another variation, the feature information includes dialogue act labels derived through a dialogue act classifier, which further informs the generative AI model whether the next reply should perform a function such as answering a question, confirming information, or expressing empathy. In yet another variation, the server maintains separate user-specific models for different communication domains, such as personal messaging and business correspondence, and selects the appropriate model based on a domain label supplied by the terminal.

In all such embodiments, the system achieves technical improvements over conventional systems. By structuring the dialogue history with explicit identifiers and timestamps, the server reduces query complexity and enables efficient retrieval of context windows. By applying preprocessing and feature extraction in advance and storing results, the server reduces redundant computation and memory usage during real-time generation. By using a sequential learning model to compute user-specific style vectors and condition information, the server enables tighter control of the generative AI model's output distribution, which leads to improved prediction accuracy and fewer rejected candidates. By integrating usage history information into retraining, the server establishes a closed feedback loop that continuously improves model performance and reduces the need for user corrections over time. These effects manifest as increased processing speed for generation requests, improved accuracy of candidate replies, reduced data transfer volume due to fewer regeneration attempts, and more efficient utilization of hardware resources such as CPU caches and GPU memory.

Furthermore, the system applies non-conventional processing flows that differ from mere human work automation. For example, the server does not simply imitate human editing of text; instead, the server calculates high-dimensional feature representations and latent style vectors, and uses these vectors as conditioning signals in a large-scale neural network. The server uses algorithmic rules to construct composite prompt sentences that integrate multiple layers of information, including historical statistics, learned patterns, and real-time emotion estimates. These composite prompts guide the generative AI model according to internal rules that are not naturally available to human editors. Because the model combines statistical sequence modeling, emotional state conditioning, and feedback-aware training, the system realizes improved computational behavior that is specific to the capabilities and constraints of modern computing hardware, thereby improving computer technology itself rather than simply computerizing a manual workflow.

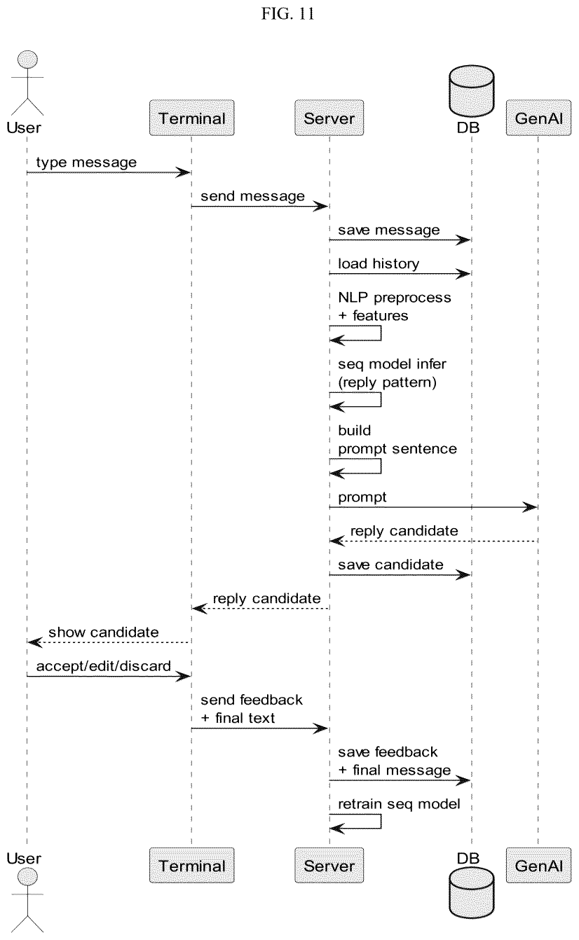

The following describes the processing flow using FIG. 11.

### Step 1

The terminal acquires user input and sends dialogue data to the server.

The terminal accepts, as input, a text string entered by the user through a keyboard or touch interface, together with metadata such as a local timestamp, a session identifier, and a user identifier. The terminal packages this data into a structured message, for example a JSON object, and transmits it to the server over a secure channel such as HTTPS. The terminal thereby performs data formatting and network transmission operations. The output of this step is a network request containing the current user message and associated metadata, delivered to the server.

### Step 2

The server receives dialogue data and stores dialogue history.

The server takes, as input, the network request from the terminal containing the current message text, the user identifier, the session identifier, and the timestamp. The server validates the data structure, converts the timestamp into a unified time format, and assigns an internal message identifier. The server then performs a database insertion operation into a dialogue_history table in a relational database, storing fields such as user_id, session_id, role, message_text, and created_at. The server thereby converts transient network data into persistent structured records. The output of this step is an updated dialogue_history table that now includes a new row representing the latest dialogue entry.

### Step 3

The server retrieves relevant dialogue history for processing.

The server uses, as input, the user identifier and session identifier of the current request. The server executes a database query to select a predetermined number of most recent dialogue entries associated with the user, optionally limited to the current session. The server orders the results by timestamp and loads them into main memory as an ordered list of message objects. During this operation, the server performs data filtering (by user and session) and sorting (by time). The output of this step is an in-memory dialogue context, which is a sequence of message objects ready for natural language preprocessing.

### Step 4

The server performs natural language preprocessing on the dialogue history.

The server receives, as input, the dialogue context (a sequence of message texts) from Step 3. The server invokes a natural language processing library to perform tokenization, lowercasing, and removal of unnecessary tokens such as stopwords and punctuation. The server may also apply lemmatization and part-of-speech tagging. For each message, the server computes a token sequence and associated linguistic annotations. The server stores these processed sequences in an intermediate data structure, such as a list of token arrays. The output of this step is a preprocessed dialogue dataset, including tokenized and normalized text representations of each message.

### Step 5

The server estimates user emotional state from preprocessed text.

The server takes, as input, the tokenized user messages produced in Step 4. The server feeds each token sequence into an emotion estimation model, such as a recurrent neural network or transformer-based classifier implemented in a deep learning framework. The server converts tokens into numeric embeddings, applies the network layers, and computes one or more numerical scores such as sentiment polarity, emotion category probabilities, or intensity measures. The server stores these scores as emotional state indices linked to corresponding message identifiers. The output of this step is an enriched preprocessed dataset where each user message has associated emotional state indices.

### Step 6

The server derives feature information representing response tendencies and expression style. The server uses, as input, the enriched preprocessed dataset containing token sequences and emotional state indices for multiple past messages and replies. The server performs statistical analysis, such as calculating average reply length, variance of length, frequency of specific linguistic patterns, distribution of sentiment values, and occurrence rates of politeness markers. The server aggregates these values over a selected history window and encodes them into a feature vector representing the user's response tendency and expression style. The server then stores this feature vector in a feature_information table in the database and also keeps a copy in memory. The output of this step is a user-specific feature vector that summarizes long-term behavioral and stylistic patterns.

### Step 7

The server infers a reply pattern using a sequential learning model.

The server receives, as input, the preprocessed dialogue dataset and the user-specific feature vector from Step 6. The server feeds sequences of tokens, along with auxiliary features such as emotional state indices and role indicators, into a sequential learning model, for example a neural network with recurrent or transformer layers. The server executes the model in inference mode to obtain latent representations such as hidden states or style embeddings. Using these internal representations, the server computes a reply pattern, including estimated preferred response length, politeness level, and stylistic category probabilities. The output of this step is a reply pattern object consisting of numerical parameters and latent vectors that characterize how the user is likely to reply in the current context.

### Step 8

The server constructs a prompt sentence for the generative AI model.

The server takes, as input, the reply pattern object from Step 7, the current dialogue context from Step 3, and the user-specific feature vector from Step 6. The server combines these inputs to generate textual descriptions of user style, constraints on length, and emotional tone. The server then assembles a prompt sentence by concatenating: (i) a system instruction describing the task, (ii) a user style description derived from the feature vector and reply pattern, (iii) excerpts of recent conversation turns formatted as dialogue, and (iv) an explicit task directive. For example, the server may produce a prompt such as:

“System: You are a generative AI model that writes replies in the user's style.

User style: The user prefers short, polite, factual messages.

Conversation:

Friend: ‘How is the weather recently?’

Task: Generate the reply that the user would most likely send.”

During this assembly, the server performs string concatenation, insertion of dynamic values, and truncation of overly long history portions. The output of this step is a fully formed prompt sentence in text form, ready to be provided as input to the generative AI model.

### Step 9

The server generates a reply candidate sentence using the generative AI model.

The server receives, as input, the constructed prompt sentence from Step 8. The server sends the prompt text to a generative AI model, which may be hosted locally or accessed via an external inference service. The server sets generation parameters such as maximum number of output tokens, sampling temperature, and nucleus sampling threshold. The generative AI model internally converts the prompt into token embeddings, applies multiple attention and feed-forward layers, and decodes a sequence of output tokens that represent a candidate reply. The server receives the sequence of output token identifiers, decodes them into a text string, and performs light post-processing to remove extraneous labels or whitespace. The output of this step is a reply candidate sentence in natural language text form.

### Step 10

The server records the reply candidate sentence and usage context.

The server takes, as input, the reply candidate sentence text from Step 9, along with the prompt sentence, the user identifier, the session identifier, and the generation parameters used. The server writes a new record into a candidate_information table in the database, storing fields such as candidate_id, user_id, session_id, prompt_text, candidate_text, and creation_time. The server thus creates a persistent link between the prompt, the candidate, and the dialogue context. The output of this step is an updated candidate_information table that contains traceable records of generated suggestions for later analysis and retraining.

### Step 11

The server transmits the reply candidate sentence to the terminal.

The server uses, as input, the reply candidate sentence and associated metadata such as candidate_id and model_version. The server creates a response message, typically a structured object including the candidate_text and identifiers, and sends it back to the terminal via a network protocol. The server thereby transforms internal database and text data into a network transmission format. The output of this step is a network response that delivers the reply candidate sentence to the terminal.

### Step 12

The terminal presents the reply candidate sentence and captures user operations.

The terminal receives, as input, the network response containing the reply candidate sentence and its metadata. The terminal parses the response, extracts the text of the candidate, and displays it in a user interface region as a modifiable suggestion. The terminal provides controls for actions such as “use as is,” “edit,” and “discard.” The user selects an action: the user may adopt the suggestion directly, modify the suggestion in an editable text field, or ignore or delete it. The terminal records the selected action and, if applicable, the edited text. The output of this step is operation information indicating the user's decision and an optional final message text.

### Step 13

The terminal sends operation information and final message text to the server.

The terminal uses, as input, the recorded operation type (adopted, edited, discarded), the candidate_id, and the final message text when applicable. The terminal constructs a structured message including this information and sends it to the server over the network. The terminal thereby converts local UI events into structured feedback data. The output of this step is a feedback request delivered to the server, containing usage history information.

### Step 14

The server updates usage history and dialogue history based on feedback.

The server receives, as input, the feedback request from the terminal containing operation information and the final message text. The server inserts or updates a record in a usage_history table with fields such as candidate_id, user_id, operation_type, and edit_distance between the candidate and the final message. If the user sent a final message, the server also writes this message as a new row in the dialogue_history table. The server may compute additional metrics, such as whether the candidate was accepted unchanged, modified slightly, or heavily altered. The output of this step is an updated usage_history table and an updated dialogue_history table reflecting the user's actual behavior.

### Step 15

The server retrains or fine-tunes the sequential learning model using updated data.

The server uses, as input, accumulated dialogue history and usage history from the database. The server constructs training examples that pair preprocessed input sequences and feature vectors with target outputs representing actual user replies, and may weight examples according to acceptance or rejection of previous candidates. The server feeds these examples into the sequential learning model in a training or fine-tuning process, computes losses such as cross-entropy or weighted loss functions, and updates model parameters by gradient-based optimization. The server may perform this retraining periodically or when sufficient new data has been collected. The output of this step is an updated set of model parameters stored in a model file and loaded into memory, improving the model's ability to predict reply patterns and to support construction of more accurate and efficient prompt sentences in subsequent iterations.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional dialog systems and content recommendation systems often process user input and usage logs in a uniform manner without deeply modeling individual communication styles or viewing preferences. As a result, such systems typically generate generic responses and recommendations that fail to align with how a particular user actually writes, thinks, and decides, thereby reducing user engagement and requiring the user to perform additional manual editing or searching.

In many existing architectures, conversation history and viewing history are merely logged as raw records and are not transformed into a coherent representation of user-specific linguistic tone, lexical tendencies, thinking patterns, and content preferences. Furthermore, those systems usually do not incorporate user feedback on suggested messages—such as adoption, editing, or ignoring of a suggestion—back into the underlying models or prompt construction logic in a systematic and automated manner. Consequently, the system cannot adaptively improve its predictions of user replies and its recommendations over time.

From a computer technology perspective, existing systems do not fully exploit generative artificial intelligence models with structured prompt sentences that encode both user characteristics and current context, nor do they coordinate between multiple data domains (dialog data and viewing data) in a unified processing pipeline. The absence of an integrated mechanism to acquire user behavior signals from a user terminal, update user characteristic information, and adjust prompt sentences and generated outputs based on those signals results in inefficiencies in data processing and an underutilization of computational resources devoted to personalization.

Additionally, prior systems typically treat conversation generation and content recommendation as separate, loosely coupled modules, thereby duplicating preprocessing, analysis, and model invocation steps. This separation can increase processing latency, complicate system architecture, and limit the ability to leverage cross-domain patterns (for example, how conversational style correlates with content preferences or emotional state). As a result, the computing system fails to deliver contextually coherent, emotionally appropriate, and user-specific outputs across both dialog and recommendation functions.

Accordingly, there is a need for a computer-implemented technique and system architecture that: (i) converts conversation history and viewing history into structured user characteristic information; (ii) uses that information to form optimized prompt sentences for a generative artificial intelligence model; (iii) integrates feedback from the user terminal as behavioral information into an iterative refinement loop; and (iv) jointly controls generation of response candidate messages and natural-language recommendation explanations. Such a technique should improve the functioning of the computer system itself by enabling more efficient and accurate processing of heterogeneous user data, more adaptive use of generative models, and more effective control of interaction between a server and a user terminal.

The specific processing by the specific processing unit 290 of the data processing device 12 in Application Example 1 is realized by the following means.

The present invention provides a server comprising a processor configured to acquire conversation history from a user and store the conversation history in an information storage device, preprocess the conversation history by using natural language processing, generate and store user characteristic information representing at least a tone, a lexical tendency, and a thinking pattern of the user, construct generation prompt sentences based on the user characteristic information and latest dialogue context, invoke a generative artificial intelligence model with the generation prompt sentences and the dialogue context to generate response candidate messages, transmit the response candidate messages to a user terminal, acquire behavioral information from the user terminal regarding adoption, editing, or ignoring of the response candidate messages by the user, update at least one of the user characteristic information and a method for constructing the generation prompt sentences based on the behavioral information, acquire viewing history information of the user, determine recommendation content information indicating information to be viewed next by calculating similarity between attribute information of viewing-target content and a preference tendency of the user, input a candidate content group including the recommendation content information and attribute information related to the candidate content group to the generative artificial intelligence model to generate, in natural language, explanation messages that explain reasons for presentation of the recommendation content information based on the user characteristic information and the viewing history information, and transmit the recommendation content information and the explanation messages to the user terminal. This enables the computer system to more efficiently and accurately personalize both dialog generation and content recommendation by dynamically updating internal user models and prompt sentences in response to user behavior, by coordinating processing of conversation data and viewing data within a unified generative-model-based pipeline, and by improving utilization of computational resources for user-specific natural language output.

The term “conversation history” refers to a sequence of interaction records between a user and a system, including at least text messages and associated metadata such as timestamps, participants, and message types, stored for later analysis and processing.

The term “information storage device” refers to a hardware or software component configured to store digital data persistently or semi-persistently, such as a database system, a file system, or a non-volatile memory unit.

The term “user characteristic information” refers to structured data representing one or more properties of a user's communication or behavior, including at least a tone, a lexical tendency, and a thinking pattern of the user, which are derived from analysis of user-related data.

The term “tone” refers to a qualitative style of expression used by the user in communication, including factors such as formality level, politeness, emotional nuance, and typical manner of speaking.

The term “lexical tendency” refers to characteristic patterns in word usage by the user, including frequently used words, preferred expressions, and typical phrase structures.

The term “thinking pattern” refers to a characteristic manner in which the user organizes, reasons about, and presents information, including tendencies such as logical structuring, preference for detail or brevity, and typical ways of asking questions or drawing conclusions.

The term “user information storage device” refers to an information storage device configured to store user-related data, including user characteristic information, in association with user identifiers for retrieval and updating.

The term “dialogue context” refers to a subset of the conversation history that includes one or more recent interaction turns relevant to a current exchange, used as contextual information for generating a new response.

The term “generation prompt sentence” refers to a text or text-like instruction, optionally including structured information, that is provided as input to a generative artificial intelligence model to specify a generation task and to condition the behavior of the model.

The term “generative artificial intelligence model” refers to a computational model that, given an input including at least a generation prompt sentence, automatically generates output data such as natural language text by predicting subsequent tokens or structures.

The term “response candidate message” refers to a message generated by the generative artificial intelligence model that predicts a reply the user is likely to make in a given dialogue context and is provided as a candidate for presentation to the user.

The term “user terminal” refers to an information processing apparatus operated by a user, such as a mobile device, a wearable device, or a personal computer, configured to exchange data with a server and present information to the user.

The term “behavioral information” refers to data indicating how the user interacted with a response candidate message or other system output, including at least whether the response candidate message was adopted, edited, or ignored, and optionally additional parameters describing the interaction.

The term “viewing history information” refers to records of content consumption by the user, including content identifiers, timestamps, viewing durations, completion status, and attributes of viewed content.

The term “viewing-target content” refers to any information unit consumable by viewing, such as a video, an image, or a program, which may be presented to the user via the user terminal.

The term “attribute information” refers to descriptive data associated with viewing-target content or other items, including but not limited to category, genre, keywords, participant information, and duration.

The term “preference tendency” refers to a representation of a user's likely interests derived from viewing history information or other behavior data, including patterns over attributes such as genres, topics, or content types.

The term “similarity” refers to a quantitative or qualitative measure expressing how closely two or more items, such as content attributes and a user's preference tendency, match or resemble each other, computed according to a predetermined metric or algorithm.

The term “recommendation content information” refers to information identifying one or more viewing-target content items determined to be suitable for the user, including at least content identifiers and optionally associated attribute information.

The term “candidate content group” refers to a set of content items that includes at least one item indicated by recommendation content information and may include additional items considered as potential recommendations.

The term “explanation message” refers to natural language text generated to explain, in a human-understandable manner, reasons or criteria for recommending particular content items or for generating particular system outputs.

The term “emotional state” refers to an estimated affective condition of the user, such as being positive, negative, neutral, excited, or anxious, inferred from analysis of conversation history, viewing history information, or other user-related signals.

In one embodiment, a server cooperates with one or more terminals operated by users to implement the claimed system. The server includes at least one processor, a main memory, a non-volatile storage device such as a magnetic disk or solid-state drive, and a network interface configured to communicate over a packet-switched network such as the Internet. The terminal includes a processor, a display device, an input device such as a touch panel or keyboard, an audio input device such as a microphone, and a network interface. The server and the terminal execute software modules implemented, for example, in a high-level programming language running on an operating system such as a general-purpose server operating system or a mobile operating system.

The server stores conversation history data and viewing history data in a database system executing on the non-volatile storage device. The server may use, for example, a relational database management system such as a general-purpose SQL database to store structured records of conversation messages and content viewing events. The server also uses an in-memory key-value store such as a general-purpose cache system to store frequently accessed user characteristic information and intermediate computation results.

The server implements a natural language processing layer by executing software libraries that perform tokenization, sentence segmentation, and part-of-speech tagging on conversation history. The server may use, for example, an open-source natural language processing library. The server converts each message of the conversation history into a sequence of tokens and annotates each token with linguistic features. The server then aggregates these token sequences for each user to construct feature vectors capturing frequency of word types, distribution of sentence lengths, ratio of interrogative sentences to declarative sentences, and other linguistic statistics.

The server generates user characteristic information by applying statistical analysis and machine learning techniques to the feature vectors derived from the conversation history. The server computes, for example, a tone score vector indicating levels of formality, directness, and emotional expressiveness, and a lexical tendency vector indicating preferred word clusters. The server also computes a thinking pattern descriptor, such as a vector representing the likelihood of certain discourse structures (for example, question-answer, claim-reason, analogy). The server stores these vectors in a user information storage device as records indexed by user identifier.

The server implements a generative AI model using a neural network architecture of the transformer type. The server deploys a multi-layer transformer-based language model having, for example, a plurality of self-attention layers, feed-forward layers, and layer normalization components. The generative AI model is parameterized by weight matrices and bias vectors trained on large-scale text corpora using supervised or self-supervised learning. The server optionally performs additional fine-tuning of the generative AI model parameters using conversation history data collected within the system, thereby adapting the model to domain-specific vocabulary and interaction styles.

The server generates a prompt sentence for the generative AI model by composing a structured text that includes: (i) instructions to the model regarding generation style; (ii) a textual description of the user characteristic information; and (iii) a representation of the latest dialogue context. The server may construct, for example, a prompt sentence such as: “You are a generative AI model that predicts how the user will reply. The user usually writes in a casual, slightly humorous tone and prefers concise messages. Based on the user's previous conversations and the following new message, generate a short reply in the user's style:

Friend: ‘Want to join our sci-fi movie marathon this weekend?’

User:”

The server serializes this prompt sentence into tokens compatible with the vocabulary of the transformer-based model and inputs the token sequence into the model. The generative AI model processes the input by propagating the token embeddings through the self-attention and feed-forward layers, computing attention weights at each layer that depend on the entire context of the prompt sentence. The model outputs a probability distribution over the vocabulary for each next token position. The server selects next tokens according to a decoding strategy such as greedy decoding or sampling with temperature control, thereby generating a response candidate message. The server aggregates the generated tokens into a text string and performs post-processing, such as trimming whitespace and filtering prohibited terms.

The server transmits the response candidate message to the terminal over a secure communication channel such as HTTPS. The terminal receives the response candidate message and renders it on the display device as a suggested reply in an input area. The terminal may present the suggestion in a distinct visual style, for example, a shaded bubble or italicized text, allowing the user to distinguish generated content from manually entered input. The terminal also allows the user to select the suggestion, partially edit it, or ignore it. When the user performs an input operation, the terminal records behavioral information indicating whether the suggestion was adopted, edited, or not used at all, and the terminal transmits this behavioral information back to the server.

The server incorporates the behavioral information into an update procedure for the user characteristic information and the prompt construction method. The server adjusts, for example, the weight parameters in a prompt-construction policy model that maps user characteristic vectors and dialogue context features to template parameters controlling tone, length, and level of detail of the prompt sentence. The server may implement this policy model as a smaller neural network that outputs prompt-control parameters such as maximum token length, politeness level, and explicitness of reasoning instructions. When the server observes that the user frequently edits generated messages to be shorter, the server decreases the target length parameter; when the user ignores messages that contain certain stylistic traits, the server gradually reduces the probability of those traits being requested in future prompt sentences. In this way, the server uses a closed feedback loop in which the behavior of the user at the terminal directly influences the internal configuration of the generative AI model interface.

The server acquires viewing history information from the terminal whenever the user starts, pauses, resumes, or completes viewing of content such as a video, image, or program. The terminal records, for example, content identifiers, start and end times, and playback position data, and the terminal transmits this information periodically or upon completion to the server. The server stores viewing events in the database and aggregates them for each user into structured records capturing counts and durations by genre, topic, content type, and other attribute information. The server computes a preference tendency vector for each user by applying algorithms such as normalized frequency counting, term-frequency-inverse-document-frequency weighting across genres, or latent factor decomposition.

The server determines recommendation content information by computing similarity measures between the user's preference tendency vector and attribute vectors associated with candidate content items stored in a content catalog. The server may represent each content item as a vector in a multi-dimensional attribute space, where dimensions correspond to genre codes, key topics, participant categories, and typical emotional tone. The server calculates similarity scores using measures such as cosine similarity or dot product, and selects content items having scores above a threshold or within the top-N ranking. The server then forms a candidate content group including the selected items and attaches associated attribute information, such as genre, main participants, and synopsis.

The server uses the generative AI model to generate explanation messages for the recommended content. The server constructs a prompt sentence describing the user's preference tendency and listing the candidate content items with their attributes. The server may construct, for example, a prompt sentence such as:

“You are a generative AI model that explains viewing recommendations. The user often watches science-fiction movies and prefers thoughtful, non-cliché stories. Given the following list of candidate movies with their genres and main participants, generate a recommendation message that suggests which movies the user should watch next and briefly explains why each movie matches the user's preferences.”

The server appends a textual description of the candidate items and provides the combined text as input to the generative AI model. The generative AI model generates explanation messages that link particular content attributes to elements of the user's preference tendency, such as “Because you liked slow-burn, idea-driven science-fiction with strong character development, this title is recommended.” The server packages the recommendation content information and the explanation messages and transmits them to the terminal.

The terminal displays the recommended items in a graphical user interface, for example, as a scrollable list of thumbnails with titles and short explanations. The terminal allows the user to select an item and initiates playback by controlling a media playback component that decodes and renders audiovisual data. The terminal also updates the viewing history information and transmits new events to the server. In this manner, the system is connected to real-world device control, including control of display hardware, audio output devices, and network-based media streaming.

The server analyzes conversation history and viewing history information jointly to estimate an emotional state of the user. The server extracts, for example, sentiment features from text messages using sentiment analysis algorithms, and it correlates these with patterns in viewing behavior such as preferred genres over time or session timestamps. The server feeds these features into an emotion estimator model implemented as a neural network classifier trained with labeled data. The classifier outputs a probability distribution over emotional categories, and the server selects an estimated emotional state based on the maximum probability. The server then adjusts prompt sentence parameters and post-processing rules for the response candidate messages and explanation messages according to the estimated emotional state. When the user appears to be in a stressed state, the server may shorten generated messages and soften wording, thereby improving user comfort and system responsiveness.

The server improves computer technology in several ways. First, by representing user characteristic information and preference tendencies as explicit vectors in memory, the server allows efficient computation of similarities and updates via vector operations, which can be accelerated using hardware such as graphics processing units. Second, by integrating conversation history and viewing history into a unified generative-model-based pipeline, the server reduces duplication of analysis steps, which reduces processing latency and storage overhead. Third, by dynamically updating prompt sentence construction based on behavioral information, the server adapts the interface between the generative AI model and the application logic, thereby improving generation accuracy without retraining the underlying model for each minor user preference change. This structured interaction between the prompt sentences and the model turns the generative AI model into a configurable component whose behavior is optimized for each user through algorithmic control executed on the server.

The server employs non-conventional processes and rules that differ from mere automation of human tasks. A human might manually read prior messages and viewing logs and craft a response or recommendation, but the server uses specific data structures, vectorized representations, and neural architectures not available in manual work. For example, the server encodes prompts and dialogue context as high-dimensional embeddings and applies multi-head self-attention across all tokens, thereby capturing long-range dependencies that humans cannot systematically track. The server also uses learned parameters in the transformer layers to automatically balance competing objectives such as informativeness, brevity, and tone consistency. These mechanisms are configured according to the user's behavioral feedback in a way that cannot be reduced to a simple rule-based automation of human decisions.

The learning procedures within the server follow specific algorithms. The server trains or fine-tunes neural networks by minimizing a loss function such as cross-entropy between predicted tokens and ground-truth tokens in conversation history. The server updates weight parameters using gradient descent-based optimization, such as stochastic gradient descent with momentum or adaptive methods. The server may also use data augmentation techniques, such as paraphrasing sentences or masking certain tokens, to increase robustness of the model to variations in user input. The server uses mini-batch training, in which batches of token sequences are processed in parallel through the model, thereby improving throughput and utilizing computing resources more effectively.

The server organizes processing modules into distinct components, such as a conversation analysis module, a user modeling module, a recommendation engine module, a prompt construction module, a generative model interface module, and a feedback adaptation module. Each module exchanges data through defined interfaces, often using structured message formats or internal data objects. This modular architecture allows the server to execute specific optimization strategies within each module; for example, the recommendation engine module can cache pre-computed content attribute vectors, while the prompt construction module can reuse templates and only change key parameters based on user characteristic information. These design choices reduce repeated computation, decrease network bandwidth consumption between modules, and lower response latency observed at the terminal.

In alternative embodiments, the server may execute the generative AI model locally on specialized hardware such as a hardware accelerator for matrix multiplication, or may call an external inference service through an application programming interface. In a further embodiment, the terminal may embed a lightweight generative AI model for local generation of short messages, while the server handles more computationally intensive tasks such as full user modeling and cross-domain recommendation explanation. In yet another embodiment, the system may adjust the degree of on-device processing versus server-side processing depending on network conditions, battery levels of the terminal, or privacy constraints. In each case, the core mechanisms of deriving user characteristic information, constructing controlled prompt sentences, invoking a generative AI model in a structured manner, and adapting prompt and model use based on behavioral information remain substantially the same.

The user interacts with the system by entering messages, selecting suggested responses, and choosing recommended content. The terminal captures these interactions through input devices and relays them to the server. The server processes the input data according to the methods described above and returns outputs that control the terminal's display behavior and, in the case of content playback, the terminal's media decoding and rendering. Thus, the system does not merely perform abstract data processing but is tied to specific operations on computing devices, storage devices, and communication links, achieving technical effects including improved response generation accuracy, reduced processing latency, more efficient storage and management of user-related data, and a more adaptive and efficient use of computational resources in generative AI-based applications.

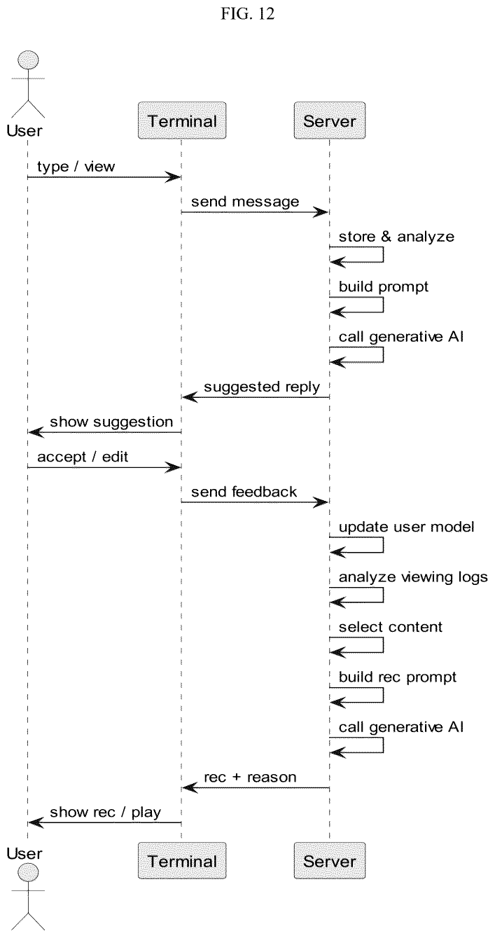

The following describes the processing flow using FIG. 12.

### Step 1

The user inputs a message or starts a voice interaction on the terminal.

The terminal receives text typed on a keyboard or touch screen, or receives audio via a microphone, as input.

The terminal, when the input is audio, converts the audio waveform into text by calling a speech-to-text function and outputs a text string representing the user's message.

The terminal packages the user identifier, timestamp, and message text into a structured request and transmits this request to the server over a network connection.

### Step 2

The server receives the request from the terminal.

The input to the server is a structured message including user identifier, timestamp, and message text.

The server validates the fields, normalizes the text (for example, by lowercasing and removing extra spaces), and stores the message and metadata into a conversation history table in a database.

The server outputs a stored conversation record identified by a conversation identifier and associated with the user.

### Step 3

The server retrieves relevant conversation history for the user.

The input to the server is the user identifier and, optionally, a time range or session identifier. The server executes a database query to fetch past messages for that user, orders them chronologically, and groups them into a dialogue context that includes at least the latest several turns of conversation.

The server outputs an ordered list of conversation messages constituting the current dialogue context.

### Step 4

The server performs natural language preprocessing on the conversation history.

The input to the server is the ordered list of conversation messages.

The server tokenizes each message into words and sentences, tags part-of-speech information, and computes statistics such as word frequency distributions, sentence length histograms, and ratios of question sentences to statement sentences.

The server outputs feature vectors representing linguistic characteristics for the user's messages.

### Step 5

The server generates or updates user characteristic information based on the feature vectors.

The input to the server is the set of feature vectors derived from the user's conversation history.

The server applies statistical aggregation and machine learning algorithms to compute a tone vector, a lexical tendency vector, and a thinking pattern descriptor, and may smooth these with previously stored vectors using weighted averaging.

The server outputs updated user characteristic information and stores it in a user information storage device indexed by the user identifier.

### Step 6

The server constructs a prompt sentence for a generative AI model to predict a response candidate message.

The input to the server is the dialogue context and the user characteristic information.

The server selects a prompt template, fills in slots with textual descriptions of the user's tone and reasoning style, and appends the latest dialogue context; for example, the server may generate: “You are a generative AI model that predicts how the user will reply. The user usually writes in a casual, slightly humorous tone and prefers concise messages. Based on the user's previous conversations and the following new message, generate a short reply in the user's style: . . . ”

The server outputs a completed prompt sentence ready for tokenization.

### Step 7

The server invokes the generative AI model with the constructed prompt sentence.

The input to the server is the prompt sentence.

The server converts the prompt sentence into a sequence of tokens according to the vocabulary of the generative AI model, sends the token sequence to the model, and causes the model to perform transformer-based computation including self-attention and feed-forward operations to calculate a probability distribution for each next token.

The server decodes the model outputs using a decoding strategy (for example, greedy or sampling) to assemble a response candidate message as a text string, and the server outputs this response candidate message.

### Step 8

The server post-processes the response candidate message and prepares it for delivery. The input to the server is the raw generated text of the response candidate message. The server trims leading and trailing whitespace, checks the message length against a maximum threshold, filters prohibited or undesired terms according to predefined rules, and adds metadata such as a generation timestamp and a flag indicating that the message is machine-generated.

The server outputs a sanitized response candidate message packaged in a structured response format.

### Step 9

The server transmits the response candidate message to the terminal.

The input to the server is the structured response candidate message.

The server sends the message over a network connection to the terminal, using a communication protocol such as HTTPS and including user identifier and conversation identifier so that the terminal can associate the suggestion with the correct chat session.

The server outputs a network response that the terminal receives and parses.

### Step 10

The terminal presents the response candidate message to the user as a suggestion.

The input to the terminal is the structured response candidate message received from the server.

The terminal extracts the message text and displays it in a suggestion area of the user interface, for example in a dedicated row under the input field or as a candidate bubble that can be tapped; the terminal may apply a specific visual style or icon to indicate that the message is a suggestion.

The terminal outputs a rendered user interface that enables the user to review and interact with the suggestion.

### Step 11

The user interacts with the suggested message.

The input to the user is the displayed suggestion on the terminal screen.

The user may tap the suggestion to adopt it as-is, edit the suggestion text in the input field, or type a completely new message and ignore the suggestion.

The user outputs one or more interaction events, such as a selection, an edit, or new text input.

### Step 12

The terminal captures behavioral information based on the user's interaction.

The input to the terminal is the user's interaction events with the suggestion and the final message that the user sends.

The terminal determines whether the suggestion was adopted without modification, adopted with edits, or ignored, and measures properties such as amount of editing or time to acceptance; the terminal then packages this behavioral information together with the final user message and relevant identifiers.

The terminal outputs a behavioral feedback report and transmits it to the server.

### Step 13

The server updates user characteristic information and prompt construction rules using the behavioral information.

The input to the server is the behavioral feedback report and the current user characteristic information.

The server analyzes correlations between feedback types (adopted, edited, ignored) and attributes of the generated messages (for example, length, tone markers, complexity) and updates parameters in a prompt-construction policy model, such as decreasing target length if long messages are frequently edited shorter; the server also adjusts weights in the user characteristic vectors to reflect the user's revealed preferences.

The server outputs updated user characteristic information and revised prompt construction parameters, which are stored for future response generation.

### Step 14

The terminal monitors and reports viewing behavior for content.

The input to the terminal is user actions such as starting, pausing, resuming, or stopping playback of videos or other content items.

The terminal records content identifiers, timestamps, playback positions, and device state, aggregates these into viewing events, and periodically transmits batches of viewing events to the server to limit communication overhead.

The terminal outputs structured viewing history data sent to the server.

### Step 15

The server aggregates viewing history and computes a preference tendency.

The input to the server is the set of viewing events associated with the user.

The server groups events by content identifier, calculates metrics such as total watch time, completion ratio, and frequency per genre or topic, and constructs a multi-dimensional preference vector where each dimension corresponds to a content attribute; the server may normalize scores across all users or all content items to emphasize relative preferences.

The server outputs a preference tendency vector for the user and stores it as part of the user characteristic information.

### Step 16

The server selects candidate content items based on similarity to the preference tendency.

The input to the server is the user's preference tendency vector and attribute vectors for content items in a content catalog.

The server computes similarity scores, for example using cosine similarity, between the user vector and each content vector, sorts items by similarity, and selects one or more top-ranked items as recommendation content information; the server may also apply constraints such as excluding already viewed items.

The server outputs a candidate content group including identifiers and attribute information of recommended items.

### Step 17

The server constructs a prompt sentence for a generative AI model to explain recommendations.

The input to the server is the candidate content group, the user's preference tendency, and user characteristic information.

The server generates descriptive text summarizing the user's viewing preferences and lists the candidate items with their attributes; the server then embeds this text into an instruction template, such as:

“You are a generative AI model that explains viewing recommendations. The user often watches science-fiction movies and prefers thoughtful, non-cliché stories. Given the following list of candidate movies with their genres and main participants, generate a recommendation message that suggests which movies the user should watch next and briefly explains why each movie matches the user's preferences.”

The server outputs a completed prompt sentence for recommendation explanation.

### Step 18

The server invokes the generative AI model to generate explanation messages for the recommendations.

The input to the server is the recommendation explanation prompt sentence and the descriptive text for candidate items.

The server tokenizes the prompt and descriptive text, feeds the tokens into the generative AI model, and causes the model to compute token probabilities and generate natural language text that links user preferences with specific content attributes; the server then aggregates generated tokens into human-readable explanation messages for each recommended item or group of items.

The server outputs explanation messages associated with the recommendation content information.

### Step 19

The server delivers recommendation content information and explanation messages to the terminal.

The input to the server is the set of recommended content identifiers, associated attribute information, and generated explanation messages.

The server composes a structured response containing content metadata and explanatory text and transmits this response to the terminal via the network, optionally compressing the payload to reduce bandwidth.

The server outputs a recommendation response that the terminal can parse and render.

### Step 20

The terminal presents recommendations and explanations to the user and controls content playback.

The input to the terminal is the recommendation response containing recommended content data and explanation messages.

The terminal displays the recommended items as a list or carousel with thumbnails, titles, and short explanation text, and provides selectable controls to initiate playback; when the user selects an item, the terminal starts a media playback application or component to decode and render the content, and simultaneously logs a new viewing event for later transmission to the server.

The terminal outputs a dynamic user interface that integrates the recommendation explanations and controls the actual rendering of content on display and audio hardware.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialogue systems that incorporate generative AI models typically treat user input as isolated messages or, at best, as simple short histories appended to a prompt. In many implementations, the conversation history is either truncated in a naive manner (for example, keeping only the most recent turns), or passed in raw form to the generative model without systematic analysis of user-specific linguistic and emotional characteristics. As a result, such systems often fail to adapt their responses to the user's consistent expression manner, preferences, and emotional state, and therefore produce generic or contextually misaligned outputs.

Furthermore, existing systems commonly embed the full dialogue history directly into the input of the generative AI model without considering computational resource constraints such as token limits, processing latency, and bandwidth consumption. This approach can lead to excessive prompt length, degraded performance, increased cost, and unstable behavior, especially when the dialogue continues over extended periods. In particular, these systems do not provide a dedicated mechanism at the server side to dynamically control the length and structure of a prompt sentence while preserving the user's characteristic style and emotional context.

In addition, many known architectures delegate most of the discourse understanding and style adaptation to the generative AI model itself, without implementing explicit, deterministic processing on the server to compute linguistic feature quantities, derive style information, and compute emotional feature quantities. Such architectures limit controllability and traceability: it is difficult to predict or verify how and why a particular response tone or style is generated, and it is difficult to enforce stable behavior across different deployments, models, or parameter settings.

Accordingly, there is a need for a computer-implemented technique that improves the operation of the dialogue system itself, by providing a server-side mechanism that: (i) records and structures dialogue history in a controlled manner; (ii) analyzes stored dialogue data using natural language processing to derive style and emotional feature quantities; (iii) constructs a prompt sentence for a generative AI model in a way that is dynamically adjusted to computational constraints while preserving the user's expression manner; and (iv) post-processes and stores generated responses so as to close the loop and continuously refine the history. By implementing these operations as explicit functions of the processor, the invention aims to improve the technical performance of the overall system in terms of personalization, resource efficiency, controllability, and robustness of AI-assisted dialogue generation.

The specific processing by the specific processing unit 290 of the data processing device 12 in Example 2 is realized by the following means.

The present invention provides a server comprising a processor and a storage device, the processor being configured to receive, via a communication network and through a terminal operated by a user, input data including an input content and user identification information, search, based on the user identification information, past dialogue history data stored in the storage device, construct a dialogue history text by extracting and arranging a predetermined number of utterance information items and response information items in time series order, perform natural language processing on the dialogue history text and the input content to calculate linguistic feature quantities and derive style information relating to an expression manner and a preference of the user, generate style description information indicating at least a tone, a degree of detail, and a type of writing style of a response based on the style information, integrate the style description information with context information including the dialogue history text and the input data to construct a prompt sentence to be input to a generative information processing model, generate request data including the prompt sentence, transmit the request data to a provision interface of the generative information processing model, receive response data including a response candidate text from the generative information processing model, execute post-processing on the response candidate text to generate a response message, and store, in the storage device, a new dialogue history in which the response message is associated with the input data and transmit the response message to the terminal as display data. This enables the dialogue system to technically improve its operation by automatically constructing and adjusting a prompt sentence that is optimized for computational constraints and user-specific style, thereby achieving more efficient use of model input capacity, more stable and controllable personalization of responses, and enhanced overall performance of computer-implemented conversational processing.

The term “processor” refers to a hardware or virtual computation unit, such as a central processing unit or a processing core in a computing environment, that executes instructions to perform logical and arithmetic operations for implementing the functions described in the present invention.

The term “storage device” refers to a physical or logical data retention component, such as a memory, a magnetic storage unit, a semiconductor storage unit, or a database system, that stores input data, dialogue history data, and generated messages used by the processor.

The term “terminal” refers to an information processing apparatus, such as a mobile communication device, a portable computing device, or a client computer, that is operated by a user to input information and to receive and display response messages from the server.

The term “communication network” refers to a wired or wireless data transmission infrastructure, such as a local area network, a wide area network, or a packet-switched network, through which the terminal and the server exchange data.

The term “input data” refers to data transmitted from the terminal to the server, the data including at least an input content representing user-entered natural language text and user identification information associated with the user.

The term “input content” refers to a portion of the input data that contains a user's natural language expression, such as a question, a request, or a statement, to which the system generates a response.

The term “user identification information” refers to information that uniquely or pseudo-uniquely identifies a user or a user account, such as an identifier, a session identifier, or a token, enabling the system to associate dialogue history data with a specific user.

The term “dialogue history data” refers to recorded interaction information between the user and the system, including past utterance information items provided by the user and past response information items generated and output by the system.

The term “utterance information item” refers to a unit of information representing a single user-side message or statement in the dialogue history, including at least natural language text and optionally metadata such as a timestamp.

The term “response information item” refers to a unit of information representing a single system-side message or response in the dialogue history, including at least natural language text and optionally metadata such as a timestamp or model-related parameters.

The term “dialogue history text” refers to a text sequence constructed from one or more utterance information items and response information items arranged in time series order, representing at least part of the past dialogue between the user and the system.

The term “time series order” refers to an arrangement of dialogue entries based on chronological information such as timestamps, so that earlier utterances and responses precede later ones.

The term “natural language processing” refers to a collection of computational techniques for analyzing, interpreting, or transforming human language text, including operations such as tokenization, part-of-speech tagging, syntactic parsing, semantic analysis, and calculation of linguistic feature quantities.

The term “linguistic feature quantities” refers to numerical or categorical values derived from the dialogue history text or input content that represent characteristics of language use, such as sentence length, type of vocabulary, presence or absence of honorific expressions, and presence or absence of colloquial expressions.

The term “style information” refers to information derived from linguistic feature quantities that represents a user's characteristic expression manner and preference, including aspects such as formality, casualness, verbosity, and typical wording patterns.

The term “expression manner” refers to a way in which a user typically expresses content in language, including tone, choice of words, sentence structure, and level of politeness or formality.

The term “preference” refers to a tendency or inclination of a user regarding how responses should be expressed, such as a preference for concise answers, detailed explanations, formal style, or casual style.

The term “style description information” refers to data representing a formalized description of an intended response style, including at least tone, degree of detail, and type of writing style, which is used to guide generation of a response by a generative information processing model.

The term “tone” refers to an attribute of a response style indicating the emotional or interpersonal attitude of the message, such as friendly, formal, casual, polite, or neutral.

The term “degree of detail” refers to an attribute of a response style indicating the amount of information provided in a response, such as concise, moderate, or extensive explanation.

The term “type of writing style” refers to a classification of the format or manner of writing in a response, such as narrative, explanatory, imperative, or conversational style.

The term “context information” refers to information used to provide situational and historical background for generating a response, including at least the dialogue history text and the input data associated with the current interaction.

The term “prompt sentence” refers to text or a text sequence constructed by the processor, including context information and style description information, which is provided as input to a generative information processing model to cause the model to generate a response candidate text.

The term “generative information processing model” refers to a machine learning model, such as a generative AI model, which receives a prompt sentence and outputs natural language text or other data by probabilistic or learned generation.

The term “request data” refers to data transmitted from the server to a provision interface of the generative information processing model, the data including at least the prompt sentence and optionally additional control parameters such as generation length or randomness level.

The term “provision interface” refers to an interface, such as an application programming interface, that enables the server to send request data to and receive response data from the generative information processing model operating on an external information processing apparatus.

The term “external information processing apparatus” refers to a separate computing environment or platform, distinct from the server, on which the generative information processing model is executed and with which the server communicates via the communication network.

The term “response data” refers to data returned from the generative information processing model to the server in reply to the request data, the data including at least a response candidate text.

The term “response candidate text” refers to text generated by the generative information processing model based on the prompt sentence, representing a candidate for the response message to be presented to the user.

The term “post-processing” refers to processing operations applied by the processor to the response candidate text after reception from the generative information processing model, including at least deletion of unnecessary character strings, limitation of length, and adjustment of sentence-ending expressions.

The term “response message” refers to a processed text or data item generated from the response candidate text by post-processing, which is intended to be transmitted to and displayed on the terminal as the system's answer to the input content.

The term “new dialogue history” refers to updated dialogue history data that includes the current input data and the corresponding response message, stored in association with each other in the storage device.

The term “display data” refers to data transmitted from the server to the terminal that includes at least the response message and is formatted so that the terminal can present the content to the user through a user interface.

The term “emotional feature quantities” refers to numerical or categorical values indicating an inferred emotional state or attitude, calculated based on the dialogue history text and the input data, and including at least one of emotional polarity, tension level, and intimacy level.

The term “emotional polarity” refers to an indication of a positive, negative, or neutral emotional orientation derived from the content of the dialogue history text and the input data.

The term “tension level” refers to an indication of a degree of arousal, stress, or urgency inferred from the dialogue history text and the input data.

The term “intimacy level” refers to an indication of a degree of closeness or familiarity inferred between the user and the system or the user and the subject matter based on the dialogue history text and the input data.

In one embodiment, a server, a terminal, and a user cooperate to implement a dialogue system that generates personalized response messages using a generative AI model based on structured dialogue history and user-specific style analysis.

The server includes at least one processor, a memory, a storage device, and a network interface. The server runs an operating system such as a UNIX-like operating system and a server-side application framework such as a web application framework. The storage device stores dialogue history data, user profile data, and configuration parameters for a generative AI model. The network interface enables the server to communicate with one or more terminals via a communication network such as the Internet, a wireless network, or a wired network.

The terminal includes a processor, a memory, a display unit, an input unit, and a communication module. The terminal runs a client application such as a mobile application or a web browser. The terminal provides a user interface for the user to enter natural language text and to view response messages from the server. The terminal may use a graphical user interface toolkit such as a native mobile UI framework or a browser rendering engine to display text fields and message bubbles.

The user operates the terminal to input questions, requests, or other natural language text. The terminal transmits input data including the input content and user identification information to the server via the communication network. The server receives the input data and stores at least part of the data temporarily in the memory and persistently in the storage device.

The server uses a database system, such as a relational database or a document-oriented database, to manage dialogue history data. The server defines a data structure in which each dialogue record includes a user identifier, a user utterance text, a system response text, a timestamp, and optional metadata such as a model version identifier and processing latency. The server stores these dialogue records in tables or collections keyed by the user identifier and timestamp.

The server retrieves, based on the user identification information in the input data, past dialogue history data from the storage device. The server sorts the retrieved records by timestamp and selects a predetermined number of utterance information items and response information items, for example, the most recent twenty pairs of user and system messages. The server constructs a dialogue history text by concatenating the user utterances and system responses with explicit markers such as “User:” and “Assistant:” and line breaks. The server thereby produces a structured textual representation of the recent dialogue context suitable for further linguistic analysis and prompt construction.

The server applies natural language processing to the dialogue history text and the current input content. The server uses text processing libraries to tokenize the text into sentences and words, to compute sentence lengths, and to detect specific lexical patterns such as polite expressions, colloquial expressions, and domain-specific terms. The server computes linguistic feature quantities, such as average sentence length, distribution of part-of-speech tags, frequency of informal phrases, ratio of interrogative sentences, and presence or absence of honorific expressions. The server aggregates these feature quantities over multiple dialogue turns to derive style information that characterizes the user's expression manner and preference.

The server represents the style information as style vectors, each component representing one aspect of the user's style (for example, formality level, conciseness level, emotional intensity, and preferred sentence ending forms). The server may normalize these components to predetermined ranges and store the style vectors in association with the user identifier. The server generates style description information by mapping the style vectors to a human-readable description, such as “casual tone, concise answers, friendly wording,” that can be embedded directly in a prompt sentence.

In one embodiment, the server further computes emotional feature quantities from the dialogue history text and the input content. The server applies sentiment analysis models or rule-based lexicons to infer emotional polarity, and uses lexical and syntactic cues to estimate tension level and intimacy level. The server expresses these emotional feature quantities as scalar values or categorical labels and updates the style description information to reflect the current emotional state, such as “user seems anxious; respond reassuringly and clearly” or “user is relaxed; respond in a light and casual tone.”

The server constructs a prompt sentence for a generative AI model by integrating the context information and the style description information. The server creates a structured text that includes at least a system instruction, the dialogue history text, the style description, and the current user question. For example, the server may construct a prompt sentence as follows: “System: You are an assistant that answers user questions using a tone that matches the user's past conversation style.

User style: The user prefers casual and friendly answers with concise explanations.

Emotion: The user appears slightly anxious; please answer in a calm and reassuring manner.

Conversation history:

User: What's the Weather Today?

Assistant: It looks sunny today.

Current user question: ‘How's the weather tomorrow?’

Task: Based on the conversation history and the current question, generate an appropriate answer in English, in a casual and concise style, while reassuring the user.”

The server may generate another example of a prompt sentence for simpler contexts: “When the user asks ‘What's the weather today?’, use the user's past conversation history and preferred casual style to generate an appropriate response. Answer in one or two friendly sentences.”

The server dynamically adjusts the length and structure of the prompt sentence. When the dialogue history becomes long, the server selectively summarizes or omits earlier parts of the history. The server identifies segments that are less relevant to the current topic and replaces them with a brief summary while retaining segments that strongly influence the user's style or the current context. This selective summarization reduces the number of tokens in the prompt sentence, improving processing speed and reducing communication load with the generative AI model, while preserving the essential style and context for personalization. The server interacts with a generative AI model that is implemented as a neural network-based language model. In one embodiment, the generative AI model is a transformer-based neural network comprising multiple self-attention layers, feed-forward layers, and layer normalization units. The model is trained on large-scale text corpora using an auto-regressive language modeling objective, in which the model predicts the next token given preceding tokens. The model uses parameters (weights and biases) learned by gradient-based optimization methods such as stochastic gradient descent or Adam, with a loss function based on cross-entropy between predicted token distributions and actual tokens.

The server uses an application programming interface (API) to access the generative AI model running on an external information processing apparatus. The server forms request data that includes the prompt sentence and, optionally, parameters such as a maximum number of output tokens, a temperature parameter to control randomness, a top-k or top-p sampling parameter to control output diversity, and a stop sequence specification to control termination of generation. The server sends the request data via HTTPS to the external apparatus, which runs the neural network forward pass by performing matrix multiplications, attention weight computations, and non-linear activation functions according to the transformer architecture.

The server receives response data including a response candidate text generated by the generative AI model. The server does not treat this text as a final answer without modification. Instead, the server applies deterministic post-processing rules, which may include trimming leading and trailing whitespace, enforcing a maximum character or token length, adjusting sentence endings to match a required politeness level, and removing extraneous prefixes or disclaimers that are inconsistent with the system's usage context. The server thereby brings the free-form output of the neural network into conformity with the desired style and length constraints, which improves consistency and usability of the responses.

The server stores the final response message along with the original input content and associated metadata as a new dialogue record in the database. This record extends the dialogue history and updates the basis for future style and emotional analysis. Over time, the server maintains a rolling window of dialogue history and style vectors, enabling the system to continuously refine personalization without storing unbounded amounts of data.

The server uses this architecture and processing flow to improve computer technology in several ways. By computing explicit linguistic and emotional feature quantities outside the generative AI model and integrating them into the prompt sentence, the server reduces the reliance on implicit inference within the model and introduces deterministic control over style and tone. This structure enables more stable and predictable behavior across different model versions and parameter settings because the style constraints are explicitly encoded in the prompt sentence and in the post-processing rules.

The server also improves computational efficiency by controlling prompt length and content. Instead of transmitting entire raw dialogue histories to the generative AI model, the server selectively summarizes and structures history. This reduces the volume of data transmitted to the external apparatus and decreases the number of tokens processed by the transformer layers, which leads to reduced latency and lower consumption of computational resources. The reduction in token count directly lowers processing time for matrix operations and attention computations inside the model, providing a measurable technical effect on processing speed and communication load.

The server improves data management by defining structured data formats for dialogue records, style vectors, and prompt components. This structure allows the server to cache intermediate results, such as style vectors and emotional feature quantities, and reuse them across multiple turns instead of recomputing them from scratch. As a result, the server skips redundant analysis work in later turns, which improves throughput and scalability when many users interact concurrently.

The server uses a generative AI model with a specific training procedure and internal architecture. The server or an associated training apparatus trains the model using mini-batches of tokenized text sequences. During training, the apparatus computes the prediction error as cross-entropy between the predicted token distribution and the true next token. The apparatus updates the model weights by backpropagating gradients through the multi-layer transformer architecture and performing parameter updates with an optimization algorithm. The apparatus may perform data augmentation by randomly masking tokens or shuffling input sequences within constraints to improve generalization. These training details support the technical nature of the generative information processing model and distinguish it from a simple rule-based text generator.

The server incorporates nonconventional rules and processing flows that differ from human manual drafting. A human operator typically would not compute numeric style vectors or emotional feature quantities and translate these into structured prompts in real time for each turn of a conversation. The server, in contrast, applies algorithmic procedures to extract style and emotional features, to assemble prompt sentences with explicit instructions and context segments, and to enforce strict post-processing constraints. These algorithmic procedures operate at machine speed and scale, yielding improvements in response consistency, personalization, and resource utilization that cannot be practically achieved by human operators.

The terminal displays the response messages provided by the server. The terminal may adjust its user interface based on metadata received from the server, such as formatting hints for the response. The user reads the displayed messages and may provide further input, which the terminal sends to the server, thereby closing the interaction loop.

In variant embodiments, the server may use different types of generative AI models, such as encoder-decoder architectures, recurrent neural networks with attention, or mixture-of-experts transformer models. The server may adapt the feature extraction pipeline to each model type while maintaining the core concept of computing explicit style and emotional quantities to guide prompt construction. The server may also vary the rule set for summarizing dialogue history, for example, by using topic segmentation or keyword extraction to decide which parts of the history to include or summarize.

In another embodiment, the server may run a lightweight language model locally in addition to using an external generative AI model. The server may use the local model to pre-screen or pre-format the prompt sentence or to simulate partial generation, thereby reducing the number of calls to the external model and further decreasing communication and computation overhead. This hybrid configuration provides an additional technical effect by balancing local computation and remote model calls.

The system is not limited to weather information dialogues. The user may ask questions related to technical support, education, entertainment, or other domains. The server adapts the same style and context analysis methods to these different domains by relying on generic linguistic and emotional feature quantities and by adjusting domain-specific configuration parameters.

Through these embodiments, the server, the terminal, and the user jointly realize a system in which the server uses a generative AI model, explicit style and emotional analysis, structured dialogue history management, and controlled prompt sentence construction to improve the technical performance of computer-implemented conversational processing beyond a mere automation of human drafting work.

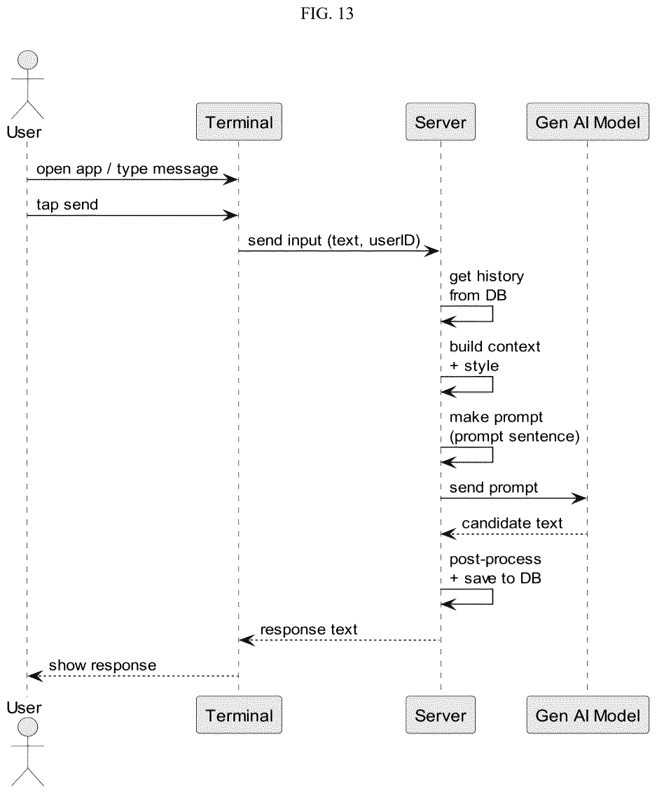

The following describes the processing flow using FIG. 13.

### Step 1

The user operates the terminal to launch a client application and display an input interface.

The terminal renders a text input field and a send button on the display unit.

Input: No prior program data (only static UI resources).

Output: A visible user interface allowing the user to enter a natural-language message.

### Step 2

The user inputs a natural-language message into the terminal.

The user types, for example, “How's the weather tomorrow?” into the input field and activates the send button.

Input: The user's keystrokes and interaction events.

Output: A text string representing the user's message stored in the terminal's working memory.

### Step 3

The terminal generates input data including the input content and user identification information.

The terminal reads the text string from the input widget, retrieves a stored user identifier or session identifier from local storage, and combines them into a structured data object.

Input: The text string entered by the user and the stored user identification information.

Output: An input data object including at least the input content and user identification information.

### Step 4

The terminal transmits the input data to the server via the communication network.

The terminal serializes the input data into a format such as JSON, encapsulates it in an HTTP request, and sends it through a communication module over a secure transport protocol.

Input: The structured input data object.

Output: A network request carrying the input data that reaches the server.

### Step 5

The server receives and parses the input data from the terminal.

The server accepts the HTTP request through a network interface, decodes the transport headers, and deserializes the request body back into an internal data structure.

Input: The network request containing the serialized input data.

Output: An internal representation of the input content and user identification information stored in server memory.

### Step 6

The server validates the input data and stores a raw record of the interaction.

The server checks that the user identification information and input content satisfy predefined constraints, such as non-emptiness and size limits, and writes a preliminary log entry to the storage device.

Input: The internal representation of the input data.

Output: A validated input data object and an initial log record associated with a timestamp.

### Step 7

The server retrieves past dialogue history data associated with the user identification information.

The server issues a query to a database using the user identification information as a key, receives a set of dialogue records, and loads them into memory.

Input: The validated input data object and the user identification information.

Output: A collection of past dialogue records including user utterances and system responses.

### Step 8

The server selects and orders a subset of dialogue records to form a relevant context window. The server sorts the retrieved records in time series order based on timestamps and selects a predetermined number of the most recent record pairs, discarding older entries beyond a context limit.

Input: the Collection of Past Dialogue Records.

Output: An ordered subset of dialogue records representing a recent dialogue window.

### Step 9

The server constructs a dialogue history text from the selected dialogue records.

The server iterates over the ordered subset, concatenates each user utterance and corresponding response with labels such as “User:” and “Assistant:”, and inserts line breaks or separators according to a predefined template.

Input: The ordered subset of dialogue records.

Output: A dialogue history text string representing the recent conversation context.

### Step 10

The server performs linguistic preprocessing on the dialogue history text and the current input content.

The server tokenizes both texts into sentences and words, normalizes character cases, and removes extraneous whitespace or control characters.

Input: The dialogue history text and the current input content.

Output: Tokenized and normalized text representations suitable for feature calculation.

### Step 11

The server calculates linguistic feature quantities from the preprocessed texts.

The server computes metrics such as average sentence length, distribution of sentence types, frequency of informal expressions, proportion of polite phrases, and diversity of vocabulary by applying counting and statistical operations to the tokenized texts.

Input: The tokenized and normalized text representations.

Output: A set of linguistic feature quantities expressed as numeric or categorical values.

### Step 12

The server derives style information representing the user's expression manner and preferences.

The server applies mapping rules or a trained classifier to transform the linguistic feature quantities into style attributes such as formality level, conciseness level, friendliness, and typical tone.

Input: The set of linguistic feature quantities.

Output: Style information summarized as style vectors or labeled attributes associated with the user.

### Step 13

The server computes emotional feature quantities from the dialogue history text and the current input content.

The server analyzes lexical indicators and syntactic patterns to estimate emotional polarity, tension level, and intimacy level, and quantifies these values for later use in tone control.

Input: The tokenized texts and, optionally, prior emotional estimates.

Output: Emotional feature quantities indicating the inferred emotional state of the user.

### Step 14

The server generates style description information based on the style information and emotional feature quantities.

The server converts numeric style and emotional values into a descriptive text, such as “The user prefers casual and friendly responses with concise explanations; the user currently appears slightly anxious.”

Input: The style information and the emotional feature quantities.

Output: A style description text string suitable for embedding in a prompt sentence.

### Step 15

The server dynamically adjusts the dialogue history text to respect computational constraints. The server estimates the token length of the dialogue history text if used directly, detects when a model-specific limit would be exceeded, and selectively summarizes or omits earlier dialogue segments while preserving key examples of user style and topic continuity.

Input: The original dialogue history text and configuration parameters indicating token limits.

Output: An adjusted dialogue history text that fits within model input constraints while retaining essential content.

### Step 16

The server constructs context information from the adjusted dialogue history text and the current input content.

The server concatenates the adjusted history and the current user question into a context block with explicit markers, such as “Conversation history:” followed by the history and “Current user question:” followed by the input content.

Input: The adjusted dialogue history text and the current input content.

Output: A context information text block representing the background for generation.

### Step 17

The server composes a prompt sentence for a generative AI model by integrating the system instruction, style description information, and context information.

The server assembles a multi-part text including a role description, the style and emotion description, the conversation history, the current user question, and a task directive, arranged in a predefined template.

Input: The style description text and the context information text block.

Output: A complete prompt sentence ready to be supplied to the generative AI model.

### Step 18

The server creates request data including the prompt sentence and generation control parameters.

The server embeds the prompt sentence into a request structure and sets parameters such as maximum output tokens, temperature, and stopping conditions.

Input: The prompt sentence and stored configuration parameters of generation control.

Output: A request data structure to be sent to the generative AI model interface.

### Step 19

The server transmits the request data to a provision interface of the generative AI model.

The server serializes the request data, opens a secure connection to the external information processing apparatus, and sends an API call to the generative AI model endpoint.

Input: The request data structure.

Output: A network request initiating generation by the external generative AI model.

### Step 20

The server receives response data including a response candidate text from the generative AI model.

The server reads the response body of the API call, parses the returned data format, and extracts the generated text sequence produced by the model.

Input: The API response from the external information processing apparatus.

Output: A response candidate text string held in server memory.

### Step 21

The server applies post-processing to the response candidate text to generate a response message.

The server removes undesired prefixes or trailing portions, enforces length limits by truncating overly long responses, and adjusts sentence endings or politeness markers to align with the previously derived style description.

Input: The response candidate text and the style description information.

Output: A finalized response message consistent with user style and system constraints.

### Step 22

The server stores a new dialogue history record linking the input and the response message. The server creates a structured record including the user identification information, the original input content, the response message, and a timestamp, and inserts this record into the dialogue history database.

Input: The validated input data and the response message.

Output: An updated database state containing the new dialogue history entry.

### Step 23

The server prepares display data for transmission to the terminal.

The server wraps the response message, and optionally metadata such as time or style indicators, into a response structure formatted for client consumption.

Input: The finalized response message.

Output: Display data ready to be encoded and transmitted to the terminal.

### Step 24

The server transmits the display data to the terminal over the communication network. The server serializes the display data, sets appropriate headers, and sends it in an HTTP response or a similar protocol message to the terminal's network address.

Input: The display data structure.

Output: A network response delivering the response message to the terminal.

### Step 25

The terminal receives and decodes the display data.

The terminal reads the network response via its communication module, parses the encoded data, and extracts the response message string and any associated metadata.

Input: The network response from the server.

Output: An internal representation of the response message stored in the terminal's working memory.

### Step 26

The terminal updates its user interface to present the response message to the user.

The terminal appends the response message as a new chat bubble or text element in the display area, scrolls the view if necessary, and optionally triggers a visual or auditory notification.

Input: The internal representation of the response message.

Output: A rendered display showing the response message to the user.

### Step 27

The user reads the displayed response and may optionally provide a follow-up input.

The user evaluates the information presented and, if desired, interacts with the input interface again, causing the overall processing loop to repeat from a new user message.

Input: The visible response message on the terminal display.

Output: A new sequence of user actions that can generate subsequent input content.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialog and recommendation systems typically generate responses by applying a generic generative AI model directly to a current user input. Such systems often ignore or underutilize conversation history, user behavior history, and stable user-specific style characteristics, and therefore produce responses that are inconsistent in tone, insensitive to the user's emotional state, and weakly personalized to the user's long-term preferences. Furthermore, conventional systems generally treat the generative AI model as an opaque component, passing only a simple prompt that describes the immediate question, without systematically constructing a prompt sentence that encodes learned style information, emotional state, and user behavior information in a structured way. As a result, the quality of generated responses is highly variable, the amount of manual editing by the user remains large, and the system fails to make full use of the capabilities of the generative AI model. In addition, conventional architectures do not effectively close the feedback loop between the user's editing and selection behavior and the operation of the generative AI model. User corrections and acceptance/rejection of suggestions are rarely stored and exploited as training data for updating style representations or for optimizing how prompts are constructed. This leads to a static personalization level that does not improve over time, and prevents the system from converging toward the user's actual communication style and preference patterns.

From a computer technology perspective, there is a need for an improved information processing system that: (i) systematically acquires and stores conversation and behavior information in a machine-usable form, (ii) computes and maintains style information and emotion information for each user by means of natural language processing and statistical processing, (iii) constructs task-specific prompt sentences that integrate such information as explicit conditions for a generative AI model, (iv) post-processes generated text to enforce consistency with user style and emotional state, and (v) uses user feedback as training data to continuously refine style learning and prompt construction. Without such mechanisms, the computational resources of the processor and generative AI model are not efficiently utilized, and the overall performance, reliability, and personalization capability of the human-computer interaction remain limited.

The specific processing by the specific processing unit 290 of the data processing device 12 in Application Example 2 is realized by the following means.

The present invention provides a server comprising a processor configured to acquire conversation information from a user, record the conversation information, and store the recorded conversation information in an information storage device; to perform preprocessing and feature extraction on the conversation information and on behavior information of the user by using natural language processing technology and statistical processing technology, and to learn style information indicating a language expression pattern, a thinking tendency, and a preference tendency of the user; to apply an emotion analysis algorithm to the conversation information to estimate an emotional state of the user and obtain the emotional state as emotion information; to construct, based on the style information, the emotion information, and the behavior information, a prompt sentence including a task description, a style condition, and an emotion condition to be given to a generative AI model that performs generative text processing, and to generate the prompt sentence; to input the prompt sentence into the generative AI model and obtain, from the generative AI model, generated text including at least one of a reply candidate of the user, response information, or recommendation information; to compare a writing style, a tone, and content of the generated text with the style information and the emotion information, and to adjust the generated text so as to conform to the language expression pattern and the emotional state of the user; and to transmit the adjusted generated text as output information to a user terminal, and further configured to receive, from the user terminal, edited information or a selection result regarding the output information and to use the edited information or the selection result as training data for updating the style information and for optimizing a method for constructing the prompt sentence. This enables improvement of computer functionality by allowing the server to more efficiently utilize computational resources of the processor and the generative AI model to generate responses that are consistently styled, emotionally appropriate, and increasingly personalized over time, thereby enhancing the technical performance, stability, and adaptability of dialog and recommendation processing in the information processing system.

The term “conversation information” refers to information including text or other linguistic data representing utterances or messages exchanged between a user and a system over time, and stored as records of dialog history.

The term “behavior information” refers to information indicating actions or selections made by a user in relation to content or system outputs, including at least one of viewing history, selection history, rating history, click history, and acceptance or rejection of suggested messages.

The term “information storage device” refers to a hardware and software combination for non-transitory storage of digital data, including at least one of a main memory, a secondary storage device, and a database system, in which conversation information, behavior information, style information, emotion information, and generated text are stored.

The term “natural language processing technology” refers to a group of computational techniques for analyzing and processing human language data, including at least tokenization, morphological analysis, syntactic analysis, semantic analysis, and feature extraction from text.

The term “statistical processing technology” refers to a group of computational techniques for analyzing data using statistical methods, including at least aggregation, frequency analysis, distribution analysis, and model parameter estimation to derive numerical features from conversation information and behavior information.

The term “style information” refers to data indicating characteristics of a user's communication style, including at least a language expression pattern, a thinking tendency, and a preference tendency, and represented as parameters, feature vectors, or model states derived from conversation information and behavior information.

The term “language expression pattern” refers to a set of features describing how a user typically expresses information, including at least average sentence length, politeness level, use of specific phrases, and preferred syntactic or lexical structures.

The term “thinking tendency” refers to a set of features representing characteristic ways in which a user structures or approaches content, including at least typical reasoning patterns, preferred information order, and recurring thematic focus.

The term “preference tendency” refers to a set of features describing a user's stable or long-term likes and dislikes regarding content or responses, including at least favored topics, genres, tones, or response lengths.

The term “emotion analysis algorithm” refers to a computational procedure that takes conversation information as input and outputs an estimate of an emotional state, including at least the polarity and category of emotion and optionally an intensity score.

The term “emotional state” refers to a psychological condition of a user, inferred from conversation information, and including at least one of positive, negative, neutral, joyful, sad, angry, stressed, tired, or expectant states.

The term “emotion information” refers to data indicating an emotional state of a user, represented as at least one of categorical labels, numerical scores, or feature vectors obtained by applying an emotion analysis algorithm to conversation information.

The term “generative AI model” refers to a trained information processing model capable of generating text content from an input prompt, the model being implemented by at least one of a neural network or another machine learning architecture that performs generative text processing.

The term “prompt sentence” refers to a text sequence provided as input to a generative AI model, the text sequence including at least a task description, a style condition, and an emotion condition to guide the content and form of generated text.

The term “task description” refers to a part of a prompt sentence that specifies a target processing task for a generative AI model, including at least one of reply generation, response generation, recommendation explanation, or content drafting.

The term “style condition” refers to a part of a prompt sentence that encodes constraints or instructions regarding a desired communication style for generated text, based on the style information of a user.

The term “emotion condition” refers to a part of a prompt sentence that encodes constraints or instructions regarding a desired emotional appropriateness or tone of generated text, based on the emotion information of a user.

The term “generated text” refers to text output produced by a generative AI model in response to a prompt sentence, including at least one of a reply candidate of a user, response information, recommendation information, or a draft communication.

The term “reply candidate” refers to generated text that is usable as a proposed response on behalf of a user to an input message or inquiry, and is subject to display and optional editing by the user.

The term “response information” refers to generated text that conveys information or an answer to a user's query, including at least explanatory content, instructions, confirmations, or status notifications.

The term “recommendation information” refers to generated text that presents suggested content items or actions to a user, including at least recommended products, services, media content, or follow-up actions, optionally with explanatory reasons.

The term “user terminal” refers to an information processing apparatus operated by a user, including at least a portable terminal, a personal computer, or another communication device capable of transmitting data to and receiving data from the server.

The term “output information” refers to data transmitted from a server to a user terminal, including at least adjusted generated text, and optionally associated metadata indicating display format or content type.

The term “edited information” refers to text or related data obtained after a user edits generated text presented as output information, and transmitted from the user terminal back to the server as feedback.

The term “selection result” refers to data indicating a user's choice or decision in response to output information, including at least selection of a specific generated message, selection of a recommended item, or explicit acceptance or rejection of a suggestion.

The term “training data” refers to a set of data samples used for learning or updating parameters of a model, the set including at least edited information and selection results associated with conversation information and behavior information.

The term “learning process” refers to a computational procedure executed by the processor to update style information or model parameters using training data, including at least one of supervised learning, semi-supervised learning, or incremental learning.

The term “optimization process” refers to a computational procedure for updating a method for constructing the prompt sentence, including at least adjustment of which features are included, how conditions are expressed, and how tasks are formulated for the generative AI model, based on training data.

In one embodiment, a server implements the claimed system as a network-based information processing apparatus. The server comprises at least one processor, main memory, a non-transitory storage device, and a communication interface connected to a communication network. The processor executes a program stored in the storage device to perform the functions described below. A terminal comprises a computing apparatus such as a smartphone, a tablet, or a personal computer, including a display unit, an input unit, a communication module, and optionally an audio output unit. A user operates the terminal to interact with the server.

The server uses an information storage device implemented by a database management system such as a relational database. The server defines multiple tables for conversation information, behavior information, style information, emotion information, and generated text. For example, a conversation history table may include fields such as user_id, message_id, timestamp, text_content, emotion_label, emotion_score, and context_type. A behavior history table may include fields such as user_id, content_id, action_type, rating_value, and action_timestamp. The server stores style information as feature vectors in a separate table, in which each record includes user_id, style_vector, update_timestamp, and auxiliary statistics such as average_sentence_length, politeness_score, and topic_distribution. The server executes a natural language processing pipeline implemented using software libraries such as spaCy or NLTK. The server applies tokenization, sentence segmentation, part-of-speech tagging, and lemmatization to the conversation information. The server computes numerical features such as token frequency vectors, bigram and trigram occurrence counts, and syntactic dependency patterns. The server computes additional stylistic features such as the proportion of honorific expressions, the distribution of sentence lengths, and the relative frequency of different parts of speech. The server aggregates these features per user to form a language expression pattern.

The server further computes features representing a thinking tendency by analyzing discourse structure and content-level characteristics. The server identifies recurring argumentation patterns, such as whether a user typically asks for justification, provides background information before conclusions, or uses particular rhetorical questions. The server models such patterns as numerical vectors, for example by using a topic model or by embedding sentences with a neural encoder and averaging the embeddings over multiple messages. The server computes preference tendency features from behavior information. The server may use a recommendation library or a matrix factorization algorithm to generate a latent preference vector per user from ratings, clicks, or selection results. The server stores these vectors as part of the style information.

The server also executes an emotion analysis algorithm implemented with sentiment analysis and emotion classification components. For example, the server applies lexicon-based sentiment scoring and machine-learned classifiers to the tokens and sentences produced by the natural language processing pipeline. The server outputs an emotional state for each message, represented by a categorical label such as “joy,” “sadness,” “anger,” “stress,” or “neutral,” and by numerical scores indicating intensity and polarity. The server stores the emotional state as emotion information linked to each message in the conversation history table.

In one embodiment, the server implements a generative AI model as a neural network configured for text generation. The neural network may be a transformer-based architecture comprising an input embedding layer, multiple self-attention layers, feed-forward layers, and a final output projection layer to a vocabulary space. The server stores model parameters, including weight matrices and bias vectors for each layer, in the storage device. The server initializes the generative AI model from a pre-trained model, and then optionally fine-tunes the model using conversation information and edited information from users.

The server constructs a style embedding network using a separate neural module. This style embedding network may be implemented as a smaller transformer encoder or as a recurrent neural network. The server inputs tokenized user messages and the previously computed feature vectors into the style embedding network. The network outputs a style embedding vector that summarizes the user's language expression pattern, thinking tendency, and preference tendency. The server saves this style embedding in the style information table and updates it as new data arrive.

The server applies a learning process implementing supervised or semi-supervised learning. The server defines a loss function for the style embedding network, for example a combination of reconstruction loss for predicting user text characteristics and contrastive loss for separating different users'styles. The server updates network weights using a gradient-based optimization algorithm. The server also defines an additional loss for prompt construction performance by measuring how well the generated text, produced using different prompt structures, is accepted or edited minimally by the user. The server uses edited information and selection results as labels indicating high-quality or low-quality generations, and adjusts the parameters controlling prompt construction accordingly.

The server constructs a prompt sentence by combining several pieces of information into a textual instruction. The server uses a template-based algorithm that concatenates: (1) a task description, (2) a style condition derived from the style embedding and statistics, and (3) an emotion condition derived from the emotion information. The server may also include explicit constraints on length, politeness, and domain vocabulary. For example, in a movie recommendation scenario, the server may generate the following prompt sentence: “You are an assistant that recommends movies. The user usually enjoys action and science fiction movies and prefers short, casual Japanese answers. The user now asks: ‘What movie do you recommend?’ (Which movie do you recommend?). In one or two sentences in natural Japanese, recommend one specific movie that fits action and science fiction, and briefly explain why it is a good match.”

In a business email drafting scenario, the server may generate the following prompt sentence: “Analyze the following description of the user's communication style: formal business Japanese, frequent use of ‘Thank you for your continued support’, polite but concise. Based on this style, draft an email in Japanese for the following task: ‘I would like to create an email proposing a new product. I want to encourage the recipient company to consider it positively.’. Keep the tone consistent with the style and make the email ready to send.” The server encodes these prompt sentences as sequences of token identifiers using the tokenizer of the generative AI model. The server then feeds the prompt token sequence into the input of the transformer network. The network propagates the embeddings through the attention layers, where the self-attention mechanism computes weighted sums of contextual token representations. The server sets generation parameters such as maximum output length, temperature, and top-k or top-p sampling values to control diversity and determinism of the generated text. The server obtains generated text by sampling tokens from the output probability distribution of the final softmax layer.

The server executes a post-processing module to adjust the generated text. The server compares the generated text with the style information and emotion information. For example, the server measures the politeness level by counting or detecting honorific expressions and compares this with a target politeness score from the style information. If the generated text deviates beyond a threshold, the server applies rule-based modifications such as inserting appropriate greetings or closings, or rewriting imperative expressions into polite requests. The server also adjusts emotional tone, for example by adding encouraging phrases when the emotion information indicates that the user is stressed or tired. The server may call a smaller correction model that is trained specifically to transform plain text into a text with a target style and emotional tone.

The server transmits the adjusted generated text as output information to the terminal via the communication interface. The terminal receives the output information, displays it in a user interface, and may also use a text-to-speech engine to produce audio output. The user reads or listens to the generated text and may edit the text. The terminal captures the edited text as edited information and sends it back to the server along with metadata such as whether the user accepted or rejected the suggestion, and whether the user selected recommended items. The server uses the edited information and selection results as training data. The server labels generated text that required minimal editing or that was accepted directly as positive examples and labels text that was heavily edited or rejected as negative examples. The server updates the style embedding network to better approximate the actual style used in accepted messages and modifies prompt construction rules accordingly. For example, the server may increase weight on emotional conditions if users frequently edit emotional tone, or adjust length constraints if users repeatedly shorten or lengthen generated messages.

By maintaining this feedback loop, the server gradually improves the match between generated text and user expectations. From a technical perspective, this mechanism improves computational efficiency and performance in several ways. First, the server reduces the average number of generation attempts and the average degree of user editing, thereby reducing communication and computation load over time. Second, because the server learns more accurate style and emotion conditions, the generative AI model requires fewer tokens to converge to appropriate content, which shortens inference time and reduces processor utilization. Third, by structuring prompt sentences with explicit style and emotion conditions, the server guides the attention patterns inside the transformer network toward relevant features, improving generation stability and reducing variance in output quality.

The described architecture provides a technical improvement over conventional systems that simply pass a raw user question into a generative AI model. In conventional systems, the model must implicitly infer style, emotion, and preferences from short, noisy inputs, leading to high uncertainty and inconsistent results. In contrast, the server in this embodiment precomputes and maintains structured style information and emotion information, and encodes these as explicit conditions in a prompt sentence. This changes the internal computation executed by the neural network by constraining the solution space and improving convergence of the attention and decoding process. As a result, the system enhances accuracy of generated text, reduces error rate in style and emotional mismatches, and improves throughput of the overall dialog system.

In another embodiment, the server executes a variant generative AI model that incorporates style and emotion conditioning through special control tokens. The server maps style vectors and emotion labels to learned control embeddings, appends corresponding control tokens at the beginning of the prompt sequence, and thereby directly influences hidden states in the transformer network. This approach further improves computational efficiency because the model can adjust behavior via control tokens without requiring long textual descriptions of style and emotion. The server still constructs a prompt sentence that describes the task, but moves style and emotion conditions into structured control tokens rather than purely natural language phrases.

In yet another embodiment, the server implements model training using mini-batches of conversation information and edited information. The server defines an objective function that combines a cross-entropy loss for predicting user-edited tokens with a regularization term that penalizes divergence between the generative AI model's output distribution and style-specific constraints. The server updates weights via an optimization algorithm such as stochastic gradient descent with momentum or adaptive moment estimation. The server may also perform data augmentation by paraphrasing user messages or by simulating small variations in style to increase robustness of the style embedding network.

In a further embodiment, the server implements caching mechanisms to reduce computation and improve response speed. For example, the server caches style embeddings and recent prompt sentence structures per user in memory so that subsequent requests can reuse these representations without recomputing features from raw conversation information. The server also caches frequently used segments of prompt sentences for common tasks, such as standard business emails or simple recommendations. This reduces both processor load and latency.

The described system is not limited to text-based communication. In another embodiment, the server processes conversation information that originates from speech input. The terminal transmits audio signals to a speech recognition module, which converts speech into text. The server then applies the same natural language processing and emotion analysis pipeline. The technical advantages of structured style and emotion conditioning remain, while the system additionally improves the efficiency of processing spoken interactions.

Because the server performs these specific data structures, algorithms, and feedback-driven learning methods, the system goes beyond mere automation of human drafting. The server modifies the internal operation of the generative AI model by supplying structured, learned style and emotion constraints and by continuously optimizing prompt sentence construction using objective performance feedback. This architecture improves execution speed, accuracy, and stability of text generation on a computing platform, and reduces communication overhead and unnecessary re-generation, thereby providing a concrete improvement to computer technology itself.

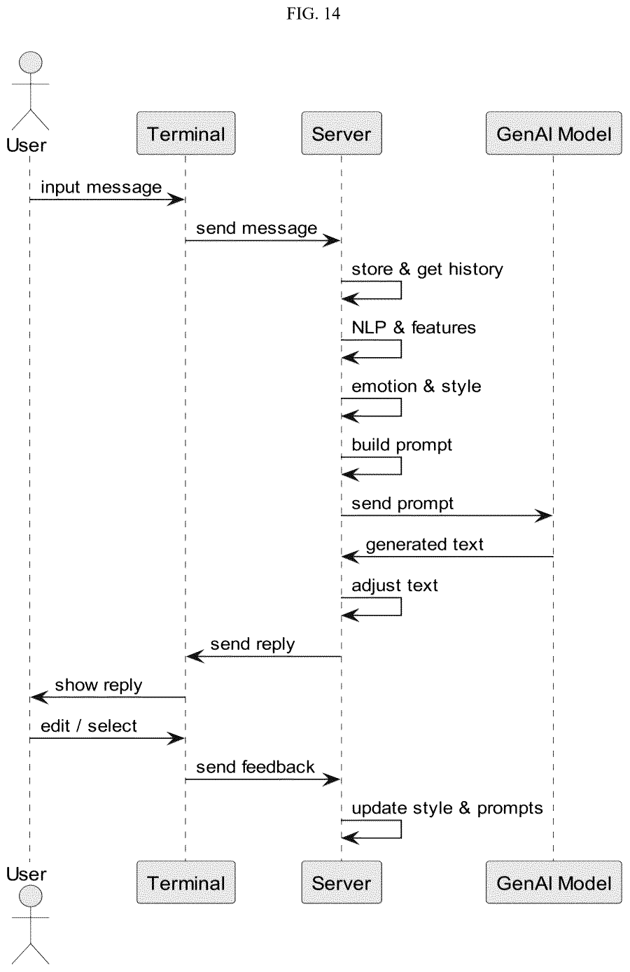

The following describes the processing flow using FIG. 14.

### Step 1

User inputs a message.

User enters text such as a question, a request for a draft, or a free-form statement into an input field on the terminal.

Input: Natural language text typed or spoken by the user.

Output: Raw user message displayed on the terminal and ready to be sent.

### Step 2

Terminal sends the message to the server.

Terminal packages the raw user message together with metadata such as user identifier, timestamp, language setting, and device type into a structured data object and transmits this object to the server via a network protocol.

Input: Raw user message and associated metadata from the user interface.

Output: Network request containing the user message and metadata delivered to the server.

### Step 3

Server Stores Conversation Information.

Server parses the received network request, extracts the text content and metadata, and inserts a new record into a conversation history table in an information storage device. The server assigns a message identifier and initializes emotion-related fields to default values.

Input: Network request containing user identifier, timestamp, and message text.

Output: New row in the conversation history table with stored conversation information and a unique message identifier.

### Step 4

Server retrieves historical conversation and behavior information.

Server queries the conversation history table and a behavior history table using the user identifier as a key and retrieves past messages, ratings, selections, and system-generated outputs associated with the user. The server loads these records into memory as structured data.

Input: User identifier and query parameters such as time range or maximum number of records.

Output: Collections of conversation records and behavior records for the user held in server memory.

### Step 5

Server executes natural language preprocessing.

Server applies a natural language processing pipeline to the current message and selected historical messages. The server tokenizes text, segments sentences, tags parts of speech, and lemmatizes words using a language processing component. The server converts tokens into normalized forms and filters out stop words where appropriate.

Input: Raw text of the current message and historical messages from memory.

Output: Tokenized and annotated text structures including token lists, sentence boundaries, and part-of-speech tags.

### Step 6

Server extracts stylistic features.

Server analyzes the annotated text to calculate statistics such as average sentence length, frequency of specific politeness markers, distribution of part-of-speech tags, and occurrence counts of character n-grams and word n-grams. The server aggregates these features per user to generate a language expression pattern.

Input: Tokenized and annotated text structures from the preprocessing step.

Output: Numerical feature vectors representing stylistic characteristics of the user.

### Step 7

Server derives preference-related features from behavior information.

Server processes the behavior records (for example, viewed items, ratings, selections) and computes a latent preference representation by applying a statistical or matrix factorization method. The server calculates, for example, a vector of preference scores across abstract content dimensions inferred from co-occurrence patterns.

Input: Behavior history records and, optionally, content descriptors.

Output: Preference tendency vector associated with the user.

### Step 8

Server estimates an emotional state.

Server applies an emotion analysis algorithm to the current message and optionally to a small window of recent messages. The server computes sentiment polarity and maps the text to one or more emotion categories such as positive, negative, stressed, or tired, with corresponding intensity scores. The server writes these values back into the conversation history record.

Input: Tokenized current message and, optionally, recent messages.

Output: Emotion label and emotion score values stored as emotion information for the current message.

### Step 9

Server generates or updates style information.

Server combines the stylistic feature vectors, the preference tendency vector, and statistical summaries of past messages to compute a style information structure. The server may pass the features through a style embedding network and obtains an embedding that compactly represents language expression pattern, thinking tendency, and preference tendency. The server stores the result in a style information table.

Input: Stylistic feature vectors, preference tendency vector, and historical statistics.

Output: Style information including a style embedding and auxiliary stylistic metrics per user.

### Step 10

Server determines the current task type.

Server inspects the user's current message, context type, and optional user interface state to classify the task (for example, reply generation, recommendation explanation, or draft creation). The server uses rule-based pattern matching or a classifier that maps input features to a task category.

Input: Current message text, metadata, and context indicators.

Output: Task type label used to guide prompt construction.

### Step 11

Server constructs a prompt sentence.

Server selects a template associated with the task type and fills the template slots with information derived from style information, emotion information, and behavior information. The server composes a natural language prompt sentence that includes at least a task description, a style condition, and an emotion condition.

Input: Task type, style information, emotion information, and behavior summary.

Output: Prompt sentence text to be supplied to the generative AI model.

### Step 12

Server prepares model input for the generative AI model.

Server tokenizes the prompt sentence using the tokenizer associated with the generative AI model, converts the tokens into numerical identifiers, and forms a sequence with any required control tokens or markers. The server sets model generation parameters such as maximum token count and sampling strategy.

Input: Prompt sentence text and model configuration parameters.

Output: Encoded input sequence and parameter set for the generative AI model.

### Step 13

Server invokes the generative AI model.

Server feeds the encoded input sequence into the generative AI model hosted locally or via a model-serving endpoint. The model processes the sequence through its layers and iteratively generates output tokens according to the configured sampling strategy until a stopping condition is met.

Input: Encoded prompt sequence and generation parameters.

Output: Generated token sequence representing a raw generated text response.

### Step 14

Server decodes the generated token sequence.

Server converts the output token identifiers back into text using the model's vocabulary mapping. The server assembles the tokens into a coherent text string and removes technical tokens such as start and end markers.

Input: Generated token sequence from the generative AI model.

Output: Raw generated text in natural language.

### Step 15

Server evaluates style alignment of the generated text.

Server applies the same or a simplified feature extraction process to the generated text to compute stylistic statistics. The server compares these statistics with target values derived from the style information and determines whether deviations exceed predefined thresholds.

Input: Generated text and target stylistic metrics from style information.

Output: Deviation measures indicating how closely the generated text matches the learned style.

### Step 16

Server adjusts the generated text based on style and emotion.

Server applies rule-based edits or invokes a secondary transformation model to modify the generated text so that the politeness level, phrasing, and emotional tone better match the user's style information and emotion information. The server may insert or replace greeting phrases, soften direct expressions, or add empathetic statements.

Input: Raw generated text, deviation measures, style information, and emotion information.

Output: Adjusted generated text that conforms to the target style and emotional state.

### Step 17

Server formats the output information.

Server packages the adjusted generated text together with auxiliary data such as suggested subject lines, recommended items, or tracking identifiers into an output structure. The server specifies how the text should be presented at the terminal (for example, as a draft message or as a recommendation description).

Input: Adjusted generated text and associated context data.

Output: Output information object ready for transmission to the terminal.

### Step 18

Server sends the output information to the terminal.

Server transmits the output information object to the terminal via the communication interface using a network protocol. The server may compress or encode the data as needed to reduce bandwidth usage.

Input: Output information object produced by the server.

Output: Network response containing the adjusted generated text and metadata delivered to the terminal.

### Step 19

Terminal presents the output information to the user.

Terminal parses the received data, extracts the adjusted generated text, and displays it in the appropriate user interface component, such as a chat bubble, an editable text area, or a recommendation list. The terminal may also initiate audio playback using a text-to-speech engine if audio output is enabled.

Input: Network response with adjusted generated text and presentation hints.

Output: Visible or audible presentation of the generated content to the user.

### Step 20

User reviews and optionally edits the generated text.

User reads or listens to the generated content and, when an editable field is provided, modifies the text to correct, shorten, expand, or otherwise refine the message. The user may accept a recommended item by selecting it, or may reject the suggestion.

Input: Presented generated content on the terminal.

Output: Edited text and user actions such as acceptance, rejection, or item selection.

### Step 21

Terminal sends edited information and selection results to the server.

Terminal collects the edited text and user action flags and encapsulates them in a feedback message. The terminal transmits this feedback to the server for learning and optimization.

Input: Edited text and user interaction data from the user interface.

Output: Feedback data packet containing edited information and selection results delivered to the server.

### Step 22

Server stores feedback as new behavior and conversation information.

Server receives the feedback packet, associates the edited text and selection results with the original generated text and user identifier, and stores these as additional records in the conversation history and behavior history tables. The server marks these entries as user-approved or user-modified outcomes.

Input: Feedback data packet from the terminal.

Output: Updated conversation and behavior history records enriched with user feedback labels.

### Step 23

Server updates style information using the feedback.

Server compares the edited text with the originally generated text to identify typical corrections and preferences. The server uses these pairs, along with selection results, as training data to refine the style embedding and statistical style metrics. The server recomputes or adjusts the style information using a learning algorithm.

Input: Pairs of generated and edited texts, selection results, and current style information.

Output: Updated style information that more accurately reflects the user's actual communication style and preferences.

### Step 24

Server optimizes prompt construction rules.

Server analyzes the relationship between different prompt sentence forms and subsequent editing effort or acceptance rates. The server adjusts parameters and templates used to construct future prompt sentences, favoring structures that historically led to high-quality, minimally edited outputs.

Input: Historical records linking prompt sentences, generated texts, edits, and acceptance metrics.

Output: Refined prompt construction strategy that will be used when generating subsequent prompt sentences.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

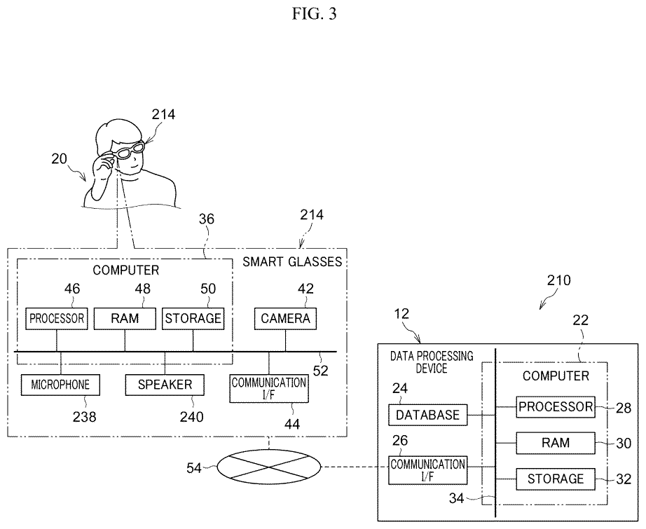

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

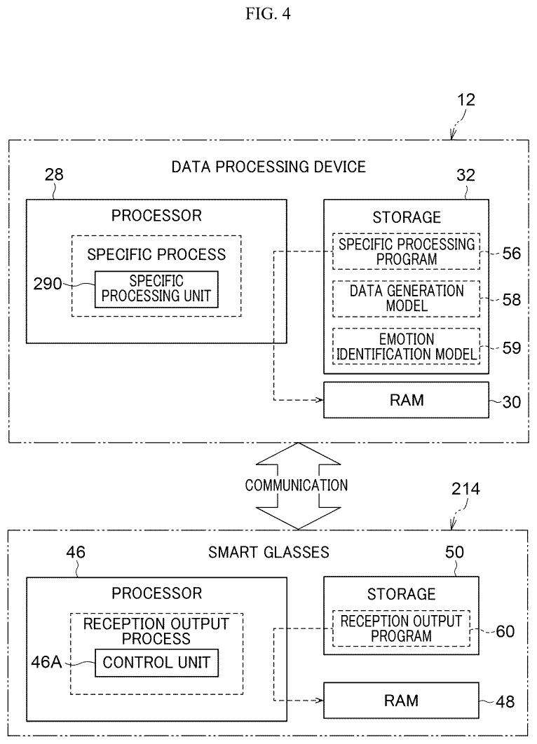

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

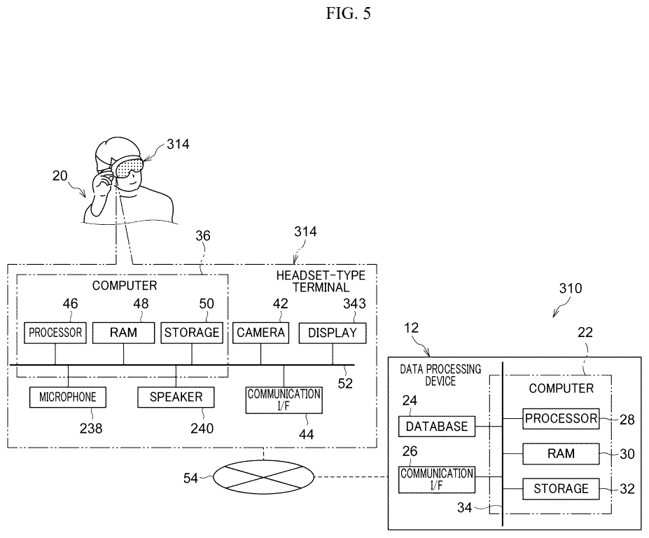

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

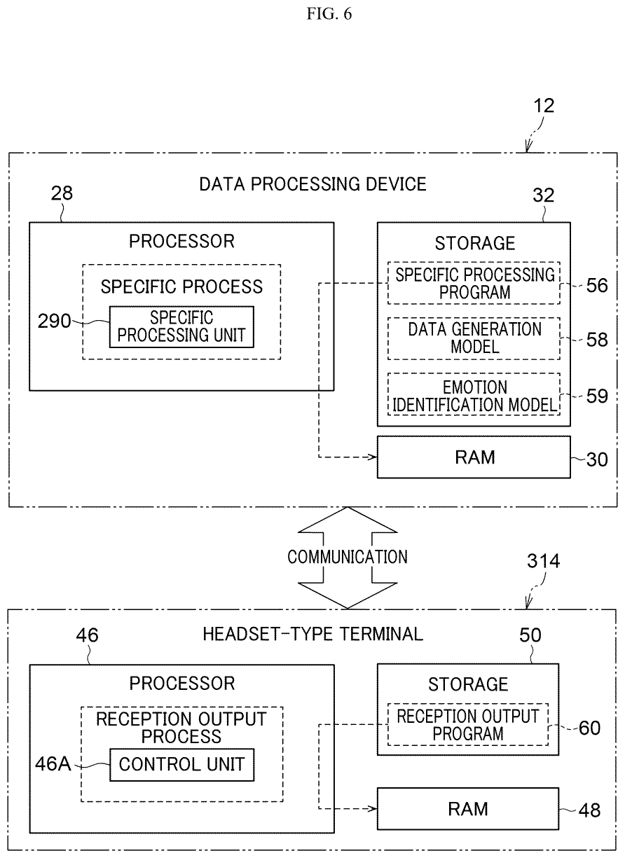

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

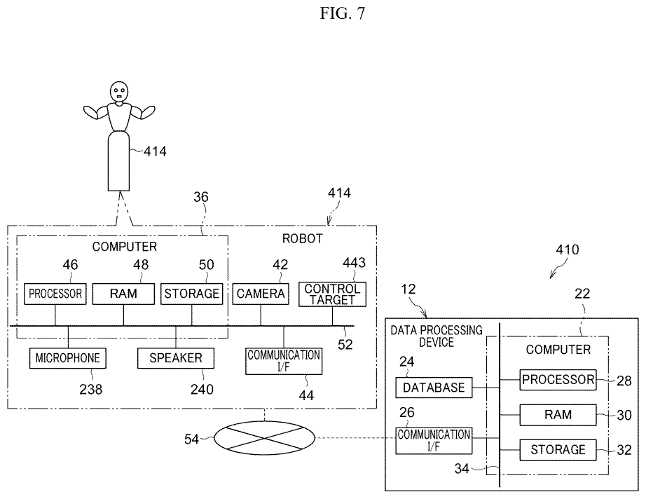

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

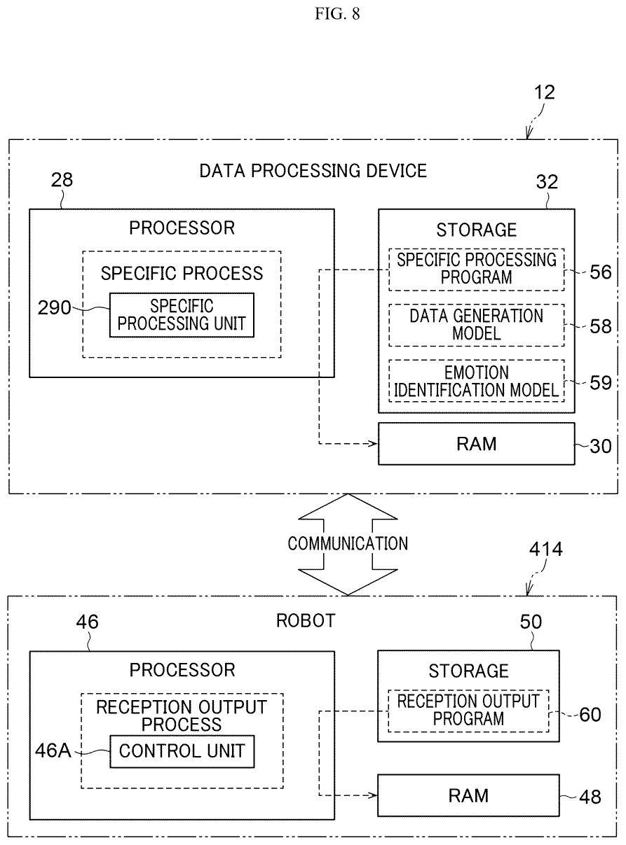

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

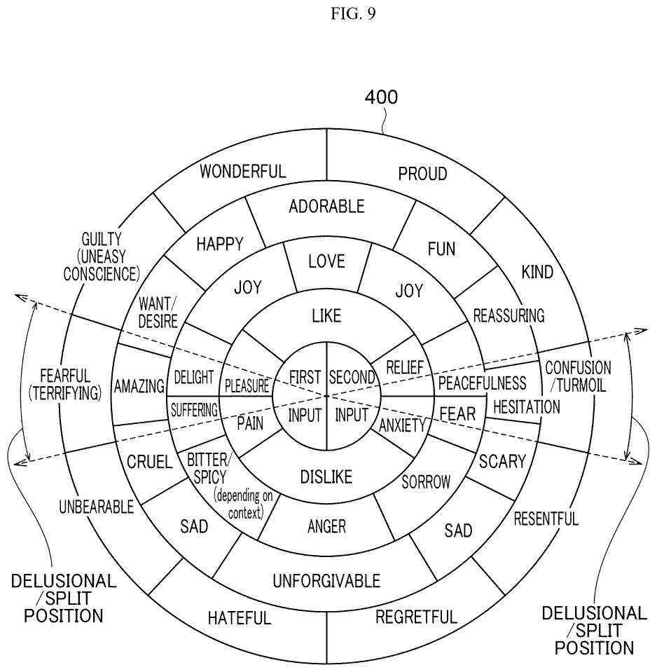

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

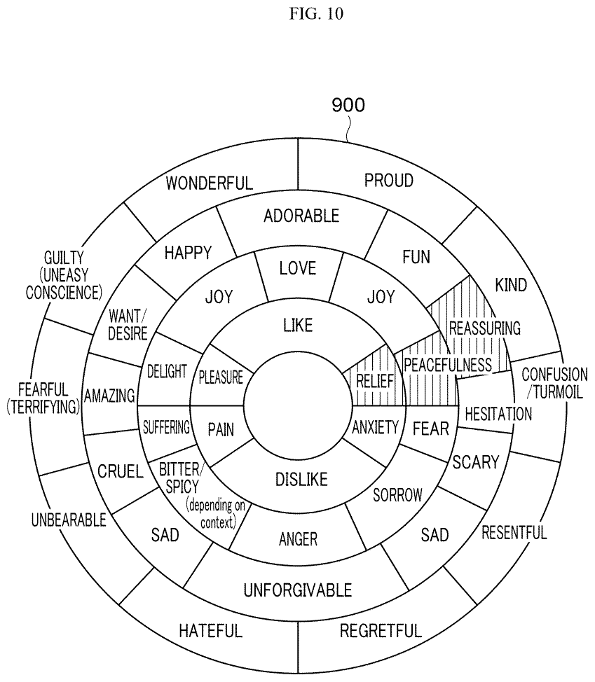

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire dialogue content with a user as dialogue history and store the dialogue history in an information management device in association with identification information and time information, and
perform preprocessing on the dialogue history stored in the information management device by using a natural language processing technique, the preprocessing including word segmentation, removal of unnecessary information, and emotion estimation, and generate feature information indicating a response tendency and an expression style of the user based on a result of the preprocessing, and
construct, based on the feature information and the dialogue history, a sequential learning model by using a machine-learning algorithm, and cause the sequential learning model to learn a reply pattern of the user, and
construct, based on the reply pattern of the user estimated by the sequential learning model and a current dialogue situation, a prompt sentence including an instruction sentence to be input to a generative information processing model, and add condition information indicating the expression style, response length, and politeness level of the user to the prompt sentence, and
input the prompt sentence to the generative information processing model and cause the generative information processing model to generate a reply candidate sentence that is expected to be transmitted by the user, and
record the generated reply candidate sentence as candidate information in association with usage history information in the information management device, and update the usage history information for use in retraining of the sequential learning model.

### Supplementary 2

The system according to supplementary 1,
wherein the processor is configured to
transmit the reply candidate sentence to a terminal device including a display device, cause the terminal device to display the reply candidate sentence as a modifiable presentation sentence, acquire operation information indicating adoption, editing, or discarding of the reply candidate sentence by the user, and transmit the operation information as the usage history information to the information management device.

### Supplementary 3

The system according to supplementary 1,
wherein the processor is configured to
calculate an emotional state index of the user from the result of the preprocessing, and adjust expression content or a writing style of the prompt sentence and the reply candidate sentence based on the emotional state index and the reply pattern of the user.

### Application Example 1

### Supplementary 1

A system comprising a processor,
wherein the processor is configured to
acquire conversation history from a user and store the conversation history in an information storage device,
preprocess the conversation history stored in the information storage device by using natural language processing technology, generate user characteristic information representing at least a tone, a lexical tendency, and a thinking pattern of the user based on the conversation history, and store the user characteristic information in a user information storage device, construct a generation prompt sentence based on the user characteristic information and latest dialogue context, and input the generation prompt sentence and the dialogue context to a generative artificial intelligence model so as to cause the generative artificial intelligence model to generate a response candidate message predicting a reply that the user will make next,
transmit the response candidate message to a user terminal and cause the response candidate message to be presented to the user via the user terminal,
acquire behavioral information from the user terminal regarding adoption, editing, or ignoring of the response candidate message by the user, and update at least one of the user characteristic information and a method for constructing the generation prompt sentence based on the behavioral information,
acquire viewing history information of the user and, based on the viewing history information, calculate similarity between attribute information of viewing-target content and a preference tendency of the user so as to determine recommendation content information indicating information to be viewed next,
input a candidate content group including the recommendation content information and attribute information related to the candidate content group to the generative artificial intelligence model, and cause the generative artificial intelligence model to generate an explanation message that explains, in natural language, a reason for presentation of the recommendation content information based on the user characteristic information and the viewing history information, and
transmit the recommendation content information and the explanation message to the user terminal and cause the recommendation content information and the explanation message to be presented to the user via the user terminal.

### Supplementary 2

The system according to supplementary 1,
wherein the processor is configured to
control the user terminal so that the user terminal displays the response candidate message as an automatic input candidate in an input field, receives a selection operation or an editing operation by the user on the response candidate message to confirm the response candidate message as a transmission message, and transmit, as the behavioral information, at least information indicating whether the response candidate message has been adopted, edited, or ignored to the processor.

### Supplementary 3

The system according to supplementary 1,
wherein the processor is configured to
analyze expression patterns included in the conversation history and the viewing history information to estimate an emotional state of the user, and adjust at least one of instruction content in the generation prompt sentence to be input to the generative artificial intelligence model and a style, a length, and a tone of the response candidate message and the explanation message in accordance with the estimated emotional state.

### Example 2

### Supplementary 1

A system comprising a processor,
wherein the processor is configured to
receive, via a communication network and through a terminal operated by a user, input data including an input content and user identification information, the input content being entered by the user through an information input interface of the terminal, and store the input data in a storage device,
search, based on the user identification information, past dialogue history data stored in the storage device, acquire the past dialogue history data, select the past dialogue history data in time series order, extract a predetermined number of utterance information items and response information items, and construct a dialogue history text from the extracted utterance information items and response information items,
perform natural language processing on the dialogue history text and on an utterance content included in the input data, calculate linguistic feature quantities including at least one of sentence length, type of vocabulary, presence or absence of honorific expressions, and presence or absence of colloquial expressions, and derive style information relating to an expression manner and a preference of the user based on the linguistic feature quantities, generate style description information indicating at least tone, degree of detail, and type of writing style of a response based on the style information, integrate the style description information with context information including the dialogue history text and the input data, and construct a prompt sentence to be input to a generative information processing model, generate request data for inputting the prompt sentence to the generative information processing model, transmit the request data to a provision interface of the generative information processing model operating on an external information processing apparatus, and receive response data including a response candidate text from the generative information processing model,
execute post-processing on the response candidate text, the post-processing including at least deletion of unnecessary character strings, length limitation, and adjustment of sentence-ending expressions, to generate a response message, store, in the storage device, a new dialogue history in which the response message is associated with the input data, and transmit the response message to the terminal as display data to be presented to the user.

### Supplementary 2

The system according to supplementary 1,
wherein the processor is configured to
summarize, in constructing the prompt sentence, utterance information items and response information items in the dialogue history text that satisfy a predetermined condition, include a result of the summarization in the prompt sentence, and dynamically adjust the prompt sentence such that a length of the context information input to the generative information processing model is controlled while maintaining the expression manner of the user.

### Supplementary 3

The system according to supplementary 1,
wherein the processor is configured to
calculate, based on the dialogue history text and the input data, emotional feature quantities including at least one of emotional polarity, tension level, and intimacy level, change the style description information based on a calculation result of the emotional feature quantities, and reflect an emotional state of the user in the prompt sentence input to the generative information processing model so as to adjust tone, manner of speech, and content of the response message generated by the generative information processing model.

### Application Example 2

### Supplementary 1

A system comprising a processor,
wherein the processor is configured to
acquire conversation information from a user, record the conversation information, and store the recorded conversation information in an information storage device,
perform preprocessing and feature extraction on the conversation information and on behavior information of the user by using natural language processing technology and statistical processing technology, and learn style information indicating a language expression pattern, a thinking tendency, and a preference tendency of the user,
apply an emotion analysis algorithm to the conversation information to estimate an emotional state of the user and obtain the emotional state as emotion information,
construct a prompt sentence including a task description, a style condition, and an emotion condition to be given to a generative AI model that performs generative text processing, based on the style information, the emotion information, and the behavior information, and generate the prompt sentence,
input the prompt sentence into the generative AI model and obtain, from the generative AI model, generated text including at least one of a reply candidate of the user, response information, or recommendation information,
compare a writing style, a tone, and content of the generated text with the style information and the emotion information, and adjust the generated text so as to conform to the language expression pattern and the emotional state of the user, and
transmit the adjusted generated text as output information to a user terminal.

### Supplementary 2

The system according to supplementary 1,
wherein the processor is configured to
cause the user terminal to present the output information received from the system in a display area or by an audio output section, receive an edit operation or a selection operation by the user with respect to the presented output information, and store edited information or a selection result, obtained by the edit operation or the selection operation, again in the information storage device as the conversation information and the behavior information.

### Supplementary 3

The system according to supplementary 1,
wherein the processor is configured to
execute, periodically or under a predetermined condition, a learning process that uses the edited information and the selection result received from the user terminal as training data to learn the style information, and an optimization process that updates a method for constructing the prompt sentence, thereby continuously improving personalization performance of the prompt sentence for the generative AI model and the generated text.

What is claimed is:

1. A system comprising:
circuitry configured to:
receive, via a communication interface coupled to a packet-switched network, dialogue content from a terminal device and store the dialogue content as dialogue history in an information management device in association with identification information and time information;
perform preprocessing on the dialogue history using a natural language processing technique, including word segmentation, removal of unnecessary information, and emotion estimation, and generate feature information indicating a response tendency and an expression style of the user based on a result of the preprocessing; and
construct a prompt sentence based on the feature information and the dialogue history, input the prompt sentence to a generative AI model, and transmit a reply candidate sentence generated by the generative AI model to the terminal device via the communication interface.

2. The system according to claim 1, wherein the circuitry is configured to construct a sequential learning model using a machine-learning algorithm based on the feature information and the dialogue history, and cause the sequential learning model to learn a reply pattern of the user.

3. The system according to claim 2, wherein the circuitry is configured to construct the prompt sentence based on a reply pattern of the user estimated by the sequential learning model and a current dialogue situation, and add condition information indicating an expression style, response length, and politeness level of the user to the prompt sentence.

4. The system according to claim 3, wherein the circuitry is configured to record the generated reply candidate sentence as candidate information in association with usage history information in the information management device, and update the usage history information for use in retraining of the sequential learning model.

5. The system according to claim 1, wherein the circuitry is configured to analyze an emotional state of the user based on data received from the terminal device via the communication interface, and adjust the reply candidate sentence based on a result of the analysis.

6. The system according to claim 5, wherein the circuitry is configured to modify at least one of a politeness level, directness, and emotional intensity of the reply candidate sentence in accordance with the analyzed emotional state of the user.

7. The system according to claim 6, wherein the circuitry is configured to perform emotion estimation on the dialogue history as part of the preprocessing, and incorporate the emotion estimation result into the feature information used to construct the prompt sentence.

8. The system according to claim 1, wherein the circuitry is configured to generate a plurality of reply candidate sentences for a single input dialogue item, rank the reply candidate sentences based on consistency with the feature information, and transmit a ranked list of reply candidate sentences to the terminal device.

9. The system according to claim 8, wherein the circuitry is configured to receive, from the terminal device via the communication interface, a selection of one of the reply candidate sentences by the user, store the selected reply candidate sentence in the information management device, and incorporate the selected reply candidate sentence into subsequent training of the sequential learning model.

10. The system according to claim 1, wherein the circuitry is configured to generate the feature information by applying statistical natural language processing to the dialogue history to extract at least word frequency information, phrase sequence frequency information, and writing style information characteristic of the user.

11. The system according to claim 10, wherein the circuitry is configured to encode the extracted feature information as a user style representation, and incorporate the user style representation into the prompt sentence as conditioning information for the generative AI model.

12. The system according to claim 1, wherein the circuitry is configured to detect temporal changes in the expression style or response tendency of the user from the dialogue history stored in the information management device, and update the feature information to reflect the detected temporal changes.

13. The system according to claim 12, wherein the circuitry is configured to schedule periodic recomputation of the feature information based on newly received dialogue content, and use the recomputed feature information to generate updated prompt sentences for the generative AI model.

14. The system according to claim 1, wherein the circuitry is configured to receive, from the terminal device, a target message to which the user desires to generate a reply, and incorporate the target message and the current dialogue situation into the prompt sentence.

15. The system according to claim 14, wherein the circuitry is configured to analyze the target message using the natural language processing technique to extract topic information and sentiment information, and incorporate the extracted topic information and sentiment information into the prompt sentence in addition to the feature information.

16. The system according to claim 1, wherein the circuitry is configured to store the dialogue history in the information management device partitioned by user identifier, and independently maintain feature information and sequential learning models for each user.

17. The system according to claim 16, wherein the circuitry is configured to apply differential privacy processing to dialogue history stored in the information management device prior to use in training the sequential learning model, to protect user-specific content from unauthorized inference.

18. A system comprising:
circuitry configured to:
receive, via a communication interface coupled to a packet-switched network, dialogue content from a terminal device and store the dialogue content as dialogue history in an information management device;
perform preprocessing on the dialogue history using a natural language processing technique to generate feature information indicating a response tendency and an expression style of a user, construct a sequential learning model using a machine-learning algorithm based on the feature information, and cause the sequential learning model to learn a reply pattern of the user;
construct a prompt sentence incorporating the reply pattern, an expression style, a response length, and a politeness level derived from the feature information, and input the prompt sentence to a generative AI model to generate a reply candidate sentence; and
transmit the reply candidate sentence to the terminal device via the communication interface, and update the information management device based on usage history information for retraining of the sequential learning model.

19. The system according to claim 18, wherein the circuitry is configured to analyze an emotional state of the user based on data received from the terminal device, adjust the reply candidate sentence based on the analyzed emotional state, and modify at least one of a politeness level, directness, and emotional intensity of the reply candidate sentence.

20. A method comprising:
receiving, via a communication interface coupled to a packet-switched network, dialogue content from a terminal device and storing the dialogue content as dialogue history in an information management device;
performing preprocessing on the dialogue history using a natural language processing technique, including word segmentation, removal of unnecessary information, and emotion estimation, and generating feature information indicating a response tendency and an expression style of the user based on a result of the preprocessing; and
constructing a prompt sentence based on the feature information and the dialogue history, inputting the prompt sentence to a generative AI model, and transmitting a reply candidate sentence generated by the generative AI model to the terminal device via the communication interface.
